(19) United States
(12) Patent Application Publication
(10) Pub. No.: US 2026/0281909 A1
(43) Pub. Date: Sep. 17, 2026

(54) FULL POWER UPLINK TRANSMISSION MODE 2 FOR 8TX UE

(71) Applicant: LENOVO (BEIJING) LIMITED, Beijing (CN)

(72) Inventors: Chenxi Zhu, Beijing (CN); Bingchao Liu, Beijing (CN); Lingling Xiao, Beijing (CN)

(21) Appl. No.: 19/167,951

(22) PCT Filed: Aug. 4, 2023
(86) PCT No.: PCT/CN2023/111137

§ 371 Date: Sep. 23, 2025

(51) Int. Cl. H04W 52/14; H04B 7/0456; H04W 72/1268; H04W 72/232

(52) U.S. Cl. CPC H04W 52/146; H04B 7/0456; H04W 72/1268; H04W 72/232

(57) ABSTRACT

Various aspects of the present disclosure relate to methods, apparatuses, and systems that support full power uplink transmission. Some implementations of the method and apparatuses described herein may further include a user equipment (UE) for wireless communication, wherein the UE is with 8 TX, the UE comprising: at least one memory; and at least one processor coupled with the at least one memory and configured to cause the UE to: receive a DCI format 0_1 or 0_2 scheduling a PUSCH with 8 antenna ports, wherein, the DCI includes a TPMI field, where the TPMI field indicates one of the TPMIs in a set for full power transmission that uses only part of the 8 antenna ports.

### TECHNICAL FIELD

The present disclosure relates to wireless communications, and more specifically to full power uplink transmission.

### BACKGROUND

A wireless communications system may include one or multiple network communication devices, such as base stations, which may be otherwise known as an eNodeB (eNB), a next-generation NodeB (gNB), or other suitable terminology. Each network communication devices, such as a base station may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

PUSCH transmission with 8 antenna ports (8TX PUSCH) is supported in NR Release 18 for advanced UE equipped with 8 antenna ports with one or multiple layers.

This disclosure targets 8TX UE full power uplink transmission.

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The present disclosure relates to methods, apparatuses, and systems that support full power uplink transmission.

Some implementations of the method and apparatuses described herein may further include a user equipment (UE) for wireless communication, wherein the UE is with 8 TX, the UE comprising: at least one memory; and at least one processor coupled with the at least one memory and configured to cause the UE to: receive a DCI format 0_1 or 0_2 scheduling a PUSCH with 8 antenna ports, wherein, the DCI includes a TPMI field, where the TPMI field indicates one of the TPMIs in a set for full power transmission that uses only part of the 8 antenna ports.

Some implementations of the method and apparatuses described herein may include a processor in a UE for wireless communication, wherein the UE is with 8 TX, the processor comprising: at least one controller coupled with at least one memory and configured to cause the processor to: receive a DCI format 0_1 or 0_2 scheduling a PUSCH with 8 antenna ports, wherein, the DCI includes a TPMI field, where the TPMI field indicates one of the TPMIs in a set for full power transmission that uses only part of the 8 antenna ports.

Some implementations of the method and apparatuses described herein may include a method performed by a user equipment (UE), wherein the UE is with 8 TX, the method comprising: receiving a DCI format 0_1 or 0_2 scheduling a PUSCH with 8 antenna ports, wherein, the DCI includes a TPMI field, where the TPMI field indicates one of the TPMIs in a set for full power transmission that uses only part of the 8 antenna ports.

In some implementations of the method and apparatuses described herein, for the UE with two coherent antenna groups each including four antenna ports, the TPMIs in the set only transmit with one of the two coherent antenna groups. The one coherent antenna group may be a predetermined coherent antenna group.

In some implementations of the method and apparatuses described herein, for the UE with four coherent antenna groups each including two antenna ports, the TPMIs in the set only transmit one or two or three of the four coherent antenna groups. The one coherent antenna group may be a predetermined coherent antenna group. The two coherent antenna groups may be two predetermined coherent antenna groups. Preferably, the two coherent antenna groups have an offset of 2 (e.g., a first antenna group and a third antenna group, or a second antenna group and a fourth antenna group). The three coherent antenna groups may be a first, a third and a fourth coherent antenna groups of the four coherent antenna groups.

In some implementations of the method and apparatuses described herein, a power scaling factor s is configured to 1.

In some implementations of the method and apparatuses described herein, the at least one processor is further configured to cause the UE to report a capability regarding the set of the TPMIs for full power transmission.

In some implementations of the method and apparatuses described herein, the at least one processor is further configured to cause the UE to report possible different number of antenna ports that can be configured for a SRS resource for codebook for full power transmission. The possible different number is one of 1 or 8, 1 or 2 or 8, 1 or 4 or 8, and 1 or 2 or 4 or 8.

Some implementations of the method and apparatuses described herein may include a base station for wireless communication, comprising: at least one memory; and at least one processor coupled with the at least one memory and configured to cause the base station to: transmit, to UE with 8 TX, a DCI format 0_1 or 0_2 scheduling a PUSCH with 8 antenna ports, wherein, the DCI includes a TPMI field, where the TPMI field indicates one of the TPMIs in a set for full power transmission that uses only part of the 8 antenna ports.

Some implementations of the method and apparatuses described herein may include a processor in a base station for wireless communication, comprising: at least one controller coupled with at least one memory and configured to cause the processor to: transmit, to UE with 8 TX, a DCI format 0_1 or 0_2 scheduling a PUSCH with 8 antenna ports, wherein, the DCI includes a TPMI field, where the TPMI field indicates one of the TPMIs in a set for full power transmission that uses only part of the 8 antenna ports.

Some implementations of the method and apparatuses described herein may include a method performed by a base station, the method comprising: transmitting, to UE with 8 TX, a DCI format 0_1 or 0_2 scheduling a PUSCH with 8 antenna ports, wherein, the DCI includes a TPMI field, where the TPMI field indicates one of the TPMIs in a set for full power transmission that uses only part of the 8 antenna ports.

In some implementations of the method and apparatuses described herein, if the UE has two coherent antenna groups each including four antenna ports, the TPMIs in the set only transmit with one of the two coherent antenna groups. The one coherent antenna group may be a predetermined coherent antenna group.

In some implementations of the method and apparatuses described herein, if the UE has four coherent antenna groups each including two antenna ports, the TPMIs in the set only transmit one or two or three of the four coherent antenna groups. The one coherent antenna group may be a predetermined coherent antenna group. The two coherent antenna groups may be two predetermined coherent antenna groups. Preferably, the two coherent antenna groups have an offset of 2 (e.g., a first antenna group and a third antenna group, or a second antenna group and a fourth antenna group). The three coherent antenna groups may be a first, a third and a fourth coherent antenna groups of the four coherent antenna groups.

In some implementations of the method and apparatuses described herein, a power scaling factor s is configured to 1.

In some implementations of the method and apparatuses described herein, the at least one processor is further configured to cause the base station to: receive a capability regarding the set of the TPMIs for full power transmission.

In some implementations of the method and apparatuses described herein, the at least one processor is further configured to cause the base station to: receive possible different number of antenna ports that can be configured for a SRS resource for codebook for full power transmission. The possible different number is one of 1 or 8, 1 or 2 or 8, 1 or 4 or 8, and 1 or 2 or 4 or 8.

### BRIEF DESCRIPTION OF THE DRAWINGS

FIG. 1 illustrates an example of a wireless communications system in accordance with aspects of the present disclosure.

FIG. 2 illustrates an example of a user equipment (UE) 200 in accordance with aspects of the present disclosure.

FIG. 3 illustrates an example of a processor 300 in accordance with aspects of the present disclosure.

FIG. 4 illustrates an example of a network equipment (NE) 400 in accordance with aspects of the present disclosure.

FIG. 5 illustrates antenna layouts with different number of antenna groups.

FIG. 6 illustrates a flowchart of method performed by a UE in accordance with aspects of the present disclosure.

FIG. 7 illustrates a flowchart of method performed by a NE in accordance with aspects of the present disclosure.

### DETAILED DESCRIPTION

Aspects of the present disclosure are described in the context of a wireless communications system.

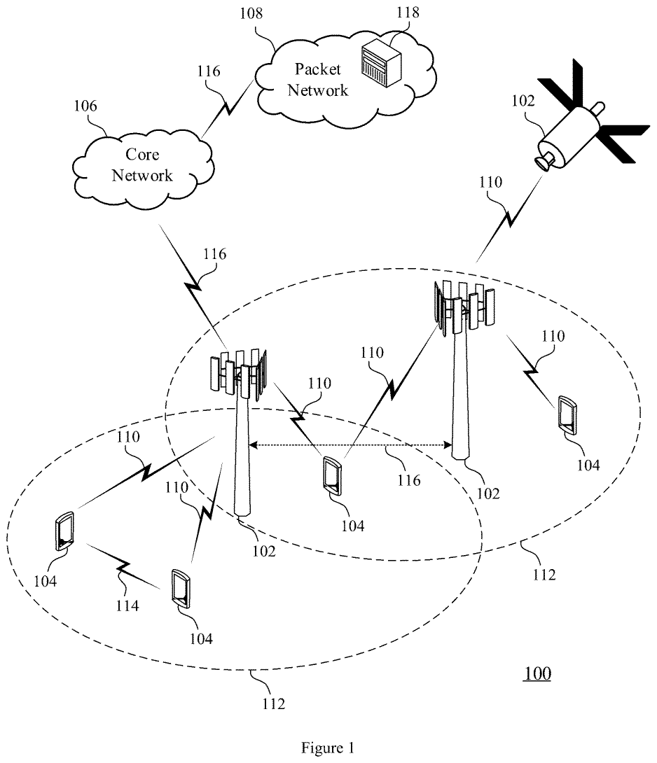

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE (Long Term Evoluation) network or an LTE-Advanced (LTE-A) network. In some other implementations, the wireless communications system 100 may be a New Radio (NR) network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link 110, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas 112 associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 114 may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links 116 (e.g., S1, N2, N2, or network interface). The network entities 102 may communicate with each other over the backhaul links 116 (e.g., via an X2, Xn, or another network interface). In some implementations, the NE 102 may communicate with each other directly. In some other implementations, the NE 102 may communicate with each other or indirectly (e.g., via the CN 106. In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network 108 over one or more backhaul links (e.g., via an S1, N2, N2, or another network interface). The packet data network 108 may include an application server 118. In some implementations, one or more UEs 104 may communicate with the application server 118. A UE 104 may establish a session (e.g., a protocol data unit (PDU) session, or the like) with the CN 106 via an NE 102. The CN 106 may route traffic (e.g., control information, data, and the like) between the UE 104 and the application server 118 using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHZ), FR4a or FR4-1 (52.6 GHZ-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

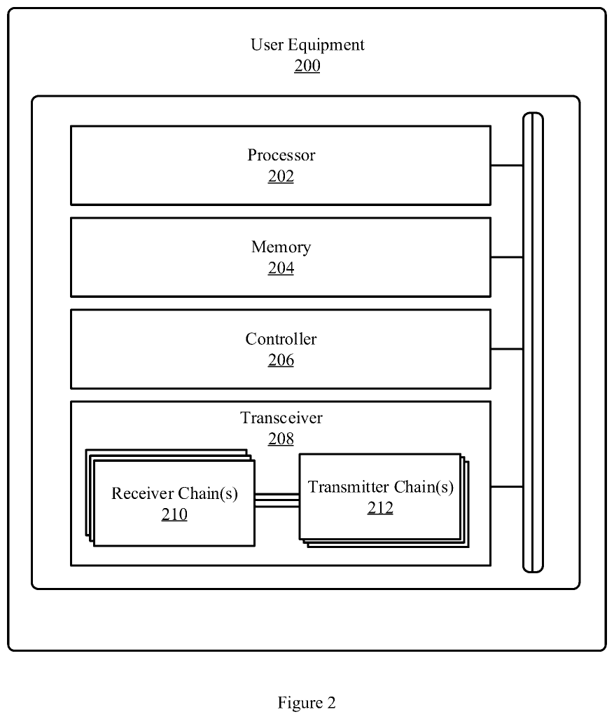

FIG. 2 illustrates an example of a UE 200 in accordance with aspects of the present disclosure. The UE 200 may include a processor 202, a memory 204, a controller 206, and a transceiver 208. The processor 202, the memory 204, the controller 206, or the transceiver 208, or various combinations thereof or various components thereof may be examples of means for performing various aspects of the present disclosure as described herein. These components may be coupled (e.g., operatively, communicatively, functionally, electronically, electrically) via one or more interfaces.

The processor 202, the memory 204, the controller 206, or the transceiver 208, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 202 may include an intelligent hardware device (e.g., a general-purpose processor, a DSP, a CPU, an ASIC, an FPGA, or any combination thereof). In some implementations, the processor 202 may be configured to operate the memory 204. In some other implementations, the memory 204 may be integrated into the processor 202. The processor 202 may be configured to execute computer-readable instructions stored in the memory 204 to cause the UE 200 to perform various functions of the present disclosure.

The memory 204 may include volatile or non-volatile memory. The memory 204 may store computer-readable, computer-executable code including instructions when executed by the processor 202 cause the UE 200 to perform various functions described herein. The code may be stored in a non-transitory computer-readable medium such the memory 204 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 202 and the memory 204 coupled with the processor 202 may be configured to cause the UE 200 to perform one or more of the functions described herein (e.g., executing, by the processor 202, instructions stored in the memory 204). For example, the processor 202 may support wireless communication at the UE 200 in accordance with examples as disclosed herein. The UE 200 may be configured to support a means for determining that a Physical Uplink Shared Channel (PUSCH) transmission is associated with a plurality of Phase-Tracking Reference Signal (PTRS) ports; and transmitting the PUSCH transmission together with the plurality of PTRS ports.

The controller 206 may manage input and output signals for the UE 200. The controller 206 may also manage peripherals not integrated into the UE 200. In some implementations, the controller 206 may utilize an operating system such as iOS®, ANDROID®, WINDOWS®, or other operating systems. In some implementations, the controller 206 may be implemented as part of the processor 202.

In some implementations, the UE 200 may include at least one transceiver 208. In some other implementations, the UE 200 may have more than one transceiver 208. The transceiver 208 may represent a wireless transceiver. The transceiver 208 may include one or more receiver chains 210, one or more transmitter chains 212, or a combination thereof.

A receiver chain 210 may be configured to receive signals (e.g., control information, data, packets) over a wireless medium. For example, the receiver chain 210 may include one or more antennas for receive the signal over the air or wireless medium. The receiver chain 210 may include at least one amplifier (e.g., a low-noise amplifier (LNA)) configured to amplify the received signal. The receiver chain 210 may include at least one demodulator configured to demodulate the receive signal and obtain the transmitted data by reversing the modulation technique applied during transmission of the signal. The receiver chain 210 may include at least one decoder for decoding the processing the demodulated signal to receive the transmitted data.

A transmitter chain 212 may be configured to generate and transmit signals (e.g., control information, data, packets). The transmitter chain 212 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 212 may also include at least one power amplifier configured to amplify the modulated signal to an appropriate power level suitable for transmission over the wireless medium. The transmitter chain 212 may also include one or more antennas for transmitting the amplified signal into the air or wireless medium.

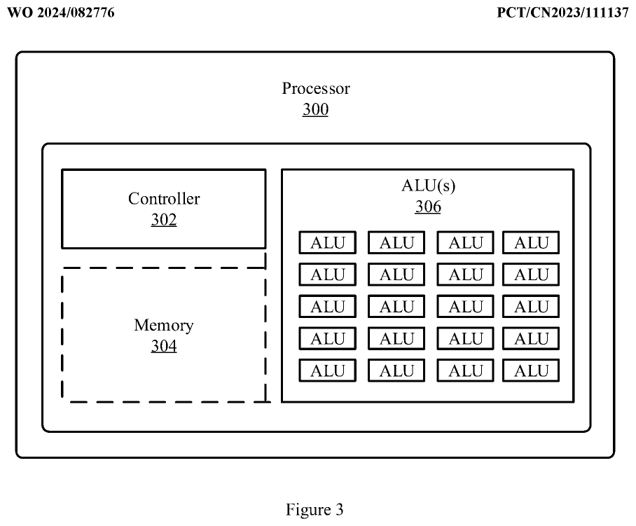

FIG. 3 illustrates an example of a processor 300 in accordance with aspects of the present disclosure. The processor 300 may be an example of a processor configured to perform various operations in accordance with examples as described herein. The processor 300 may include a controller 302 configured to perform various operations in accordance with examples as described herein. The processor 300 may optionally include at least one memory 304, which may be, for example, an L1/L2/L3 cache. Additionally, or alternatively, the processor 300 may optionally include one or more arithmetic-logic units (ALUs) 306. One or more of these components may be in electronic communication or otherwise coupled (e.g., operatively, communicatively, functionally, electronically, electrically) via one or more interfaces (e.g., buses).

The processor 300 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 300) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 302 may be configured to manage and coordinate various operations (e.g., signaling, receiving, obtaining, retrieving, transmitting, outputting, forwarding, storing, determining, identifying, accessing, writing, reading) of the processor 300 to cause the processor 300 to support various operations in accordance with examples as described herein. For example, the controller 302 may operate as a control unit of the processor 300, generating control signals that manage the operation of various components of the processor 300. These control signals include enabling or disabling functional units, selecting data paths, initiating memory access, and coordinating timing of operations.

The controller 302 may be configured to fetch (e.g., obtain, retrieve, receive) instructions from the memory 304 and determine subsequent instruction(s) to be executed to cause the processor 300 to support various operations in accordance with examples as described herein. The controller 302 may be configured to track memory address of instructions associated with the memory 304. The controller 302 may be configured to decode instructions to determine the operation to be performed and the operands involved. For example, the controller 302 may be configured to interpret the instruction and determine control signals to be output to other components of the processor 300 to cause the processor 300 to support various operations in accordance with examples as described herein. Additionally, or alternatively, the controller 302 may be configured to manage flow of data within the processor 300. The controller 302 may be configured to control transfer of data between registers, arithmetic logic units (ALUs), and other functional units of the processor 300.

The memory 304 may include one or more caches (e.g., memory local to or included in the processor 300 or other memory, such RAM, ROM, DRAM, SDRAM, SRAM, MRAM, flash memory, etc. In some implementations, the memory 304 may reside within or on a processor chipset (e.g., local to the processor 300). In some other implementations, the memory 304 may reside external to the processor chipset (e.g., remote to the processor 300).

The memory 304 may store computer-readable, computer-executable code including instructions that, when executed by the processor 300, cause the processor 300 to perform various functions described herein. The code may be stored in a non-transitory computer-readable medium such as system memory or another type of memory. The controller 302 and/or the processor 300 may be configured to execute computer-readable instructions stored in the memory 304 to cause the processor 300 to perform various functions. For example, the processor 300 and/or the controller 302 may be coupled with or to the memory 304, the processor 300, the controller 302, and the memory 304 may be configured to perform various functions described herein. In some examples, the processor 300 may include multiple processors and the memory 304 may include multiple memories. One or more of the multiple processors may be coupled with one or more of the multiple memories, which may, individually or collectively, be configured to perform various functions herein.

The one or more ALUs 306 may be configured to support various operations in accordance with examples as described herein. In some implementations, the one or more ALUs 306 may reside within or on a processor chipset (e.g., the processor 300). In some other implementations, the one or more ALUs 306 may reside external to the processor chipset (e.g., the processor 300). One or more ALUs 306 may perform one or more computations such as addition, subtraction, multiplication, and division on data. For example, one or more ALUs 306 may receive input operands and an operation code, which determines an operation to be executed. One or more ALUs 306 be configured with a variety of logical and arithmetic circuits, including adders, subtractors, shifters, and logic gates, to process and manipulate the data according to the operation. Additionally, or alternatively, the one or more ALUs 306 may support logical operations such as AND, OR, exclusive-OR (XOR), not-OR (NOR), and not-AND (NAND), enabling the one or more ALUs 306 to handle conditional operations, comparisons, and bitwise operations.

The processor 300 may support wireless communication in accordance with examples as disclosed herein. The processor 300 may be configured to or operable to support a means for determining that a Physical Uplink Shared Channel (PUSCH) transmission is associated with a plurality of Phase-Tracking Reference Signal (PTRS) ports; and transmitting the PUSCH transmission together with the plurality of PTRS ports.

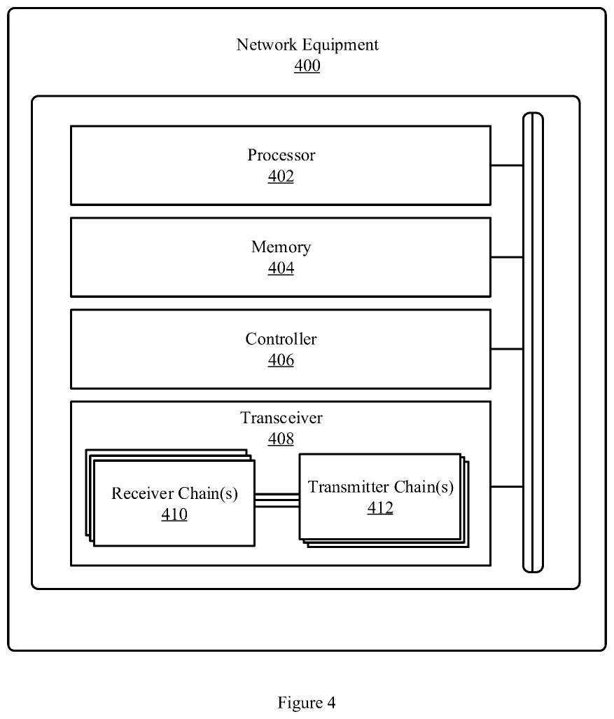

FIG. 4 illustrates an example of a NE 400 in accordance with aspects of the present disclosure. The NE 400 may include a processor 402, a memory 404, a controller 406, and a transceiver 408. The processor 402, the memory 404, the controller 406, or the transceiver 408, or various combinations thereof or various components thereof may be examples of means for performing various aspects of the present disclosure as described herein. These components may be coupled (e.g., operatively, communicatively, functionally, electronically, electrically) via one or more interfaces.

The processor 402, the memory 404, the controller 406, or the transceiver 408, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 402 may include an intelligent hardware device (e.g., a general-purpose processor, a DSP, a CPU, an ASIC, an FPGA, or any combination thereof). In some implementations, the processor 402 may be configured to operate the memory 404. In some other implementations, the memory 404 may be integrated into the processor 402. The processor 402 may be configured to execute computer-readable instructions stored in the memory 404 to cause the NE 400 to perform various functions of the present disclosure.

The memory 404 may include volatile or non-volatile memory. The memory 404 may store computer-readable, computer-executable code including instructions when executed by the processor 402 cause the NE 400 to perform various functions described herein. The code may be stored in a non-transitory computer-readable medium such the memory 404 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 402 and the memory 404 coupled with the processor 402 may be configured to cause the NE 400 to perform one or more of the functions described herein (e.g., executing, by the processor 402, instructions stored in the memory 404). For example, the processor 402 may support wireless communication at the NE 400 in accordance with examples as disclosed herein. The NE 400 may be configured to support a means for determining that a Physical Uplink Shared Channel (PUSCH) transmission is associated with a plurality of Phase-Tracking Reference Signal (PTRS) ports; and receiving the PUSCH transmission together with the plurality of PTRS ports.

The controller 406 may manage input and output signals for the NE 400. The controller 406 may also manage peripherals not integrated into the NE 400. In some implementations, the controller 406 may utilize an operating system such as iOS®, ANDROID®, WINDOWS®, or other operating systems. In some implementations, the controller 406 may be implemented as part of the processor 402.

In some implementations, the NE 400 may include at least one transceiver 408. In some other implementations, the NE 400 may have more than one transceiver 408. The transceiver 408 may represent a wireless transceiver. The transceiver 408 may include one or more receiver chains 410, one or more transmitter chains 412, or a combination thereof.

A receiver chain 410 may be configured to receive signals (e.g., control information, data, packets) over a wireless medium. For example, the receiver chain 410 may include one or more antennas for receive the signal over the air or wireless medium. The receiver chain 410 may include at least one amplifier (e.g., a low-noise amplifier (LNA)) configured to amplify the received signal. The receiver chain 410 may include at least one demodulator configured to demodulate the receive signal and obtain the transmitted data by reversing the modulation technique applied during transmission of the signal. The receiver chain 410 may include at least one decoder for decoding the processing the demodulated signal to receive the transmitted data.

A transmitter chain 412 may be configured to generate and transmit signals (e.g., control information, data, packets). The transmitter chain 412 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 412 may also include at least one power amplifier configured to amplify the modulated signal to an appropriate power level suitable for transmission over the wireless medium. The transmitter chain 412 may also include one or more antennas for transmitting the amplified signal into the air or wireless medium.

The UE can be configured in two different modes for PUSCH multi-antenna precoding, referred as codebook (CB) based transmission and non-codebook (nCB) based transmission, respectively. When the UE is configured with codebook based PUSCH transmission, one SRS resource set used for codebook can be configured in a BWP of a cell for the UE. When the UE is configured with non-codebook based PUSCH transmission, one SRS resource set used for non-codebook can be configured in a BWP of a cell for the UE.

To enable codebook based PUSCH transmission, the UE shall be configured to transmit one or more SRS resources used for codebook for uplink channel measurement. Based on the measurements on the configured SRS resources transmitted by the UE, the gNB determines a suitable transmission rank (which may be abbreviated as “rank” hereinafter) and the precoding matrix from a pre-defined codebook, which includes a set of precoding matrices with different ranks, and sends the information to the UE when scheduling a PUSCH transmission.

When a UE is equipped with 8 antenna ports (e.g., PUSCH or SRS antenna ports), the base unit (e.g., gNB) may send to the UE a DCI (e.g., DCI with format 0_1 or DCI with format 0_2) scheduling dynamically scheduled PUSCH or type 2 configured-grant PUSCH with up to 8 layers (i.e., PUSCH layers) or a RRC message (e.g., configuredGrantConfig) to configure type 1 configured-grant PUSCH with up to 8 layers. The 8 antenna ports (e.g., PUSCH or SRS antenna ports) may be numbered as PUSCH or SRS antenna ports 1000, 1001, 1002, 1003, 1004, 1005, 1006, and 1007. Incidentally, a brief summary of CG PUSCH is as follows. CG (configured grant) PUSCH is used for semi-static UL traffic, which can be transmitted without dedicated scheduling DCI. Two types of CG PUSCH are specified in NR Release 15. For type 1 CG PUSCH, all the information used for the PUSCH transmission are configured by RRC signaling and the CG PUSCH can be periodically transmitted according to the configured period. For type 2 CG PUSCH, part of information used for the PUSCH transmission is configured by RRC signaling, while the other information is indicated by an activation DCI. Type 2 CG PUSCH can only be periodically transmitted upon receiving the activation DCI. When the UE receives a deactivation DCI to deactivate type 2 CG PUSCH, the corresponding PUSCH shall not be transmitted. Both type 1 CG PUSCH and type 2 CG PUSCH are configured by configured grant PUSCH configuration (i.e., by higher layer parameter configuredGrantConfig IE) and each configuredGrantConfig has an ID.

When the PUSCH layers are transmitted from the UE, a precoding matrix is used to perform UL precoding on modulated data in codebook based PUSCH transmission. The UE shall perform UL precoding according to Equation 1.

$$[ \begin{matrix}{z}_{0}^{( {P}_{0} )} ( i ) \\ ⋮ \\ {z}_{0}^{( {P}_{ρ - 1} )} ( i )\end{matrix} ] = {W}_{0} [ \begin{matrix}{y}_{0}^{( 0 )} ( i ) \\ ⋮ \\ {y}_{0}^{( {ν}_{0} - 1 )} ( i )\end{matrix} ] \qquad Equation 1$$

where, the block of vector

$${[ {y}_{0}^{( 0 )} ( i ) … {y}_{0}^{( {ν}_{0} - 1 )} ( i ) ]}^{T}$$

is the modulated data that will be transmitted; W₀ is the precoding matrix applied to the block of vector; and the block of vector

$${[ {z}_{0}^{( {P}_{0} )} ( i ) … {z}_{0}^{( {P}_{ρ - 1} )} ( i ) ]}^{T}$$

is the pre-coded data to be transmitted by the UE. ν₀ indicates the number of PUSCH layers or the rank of the PUSCH. P₀ corresponds to PUSCH antenna port 1000 and P_{ρ-1} corresponds to PUSCH antenna port 1000+ρ−1. In this invention, ρ=8.

Coherent transmission is described as follows.

If a UE reports a capability of full-coherent and 8 antenna ports (i.e., PUSCH antenna port 1000, 1001, 1002, 1003, 1004, 1005, 1006 and 1007), all 8 PUSCH antenna ports can be used for coherent transmission of a PUSCH layer. For example, the precoding vector used for each layer can have 8 non-zero elements, e.g.,

$$W = {\frac{1}{2 \sqrt{2}} [ 1 , j , 1 , j , 1 , j , 1 , j ]}^{T}$$

a valid precoding vector for a rank 1 PUSCH transmission with 8 full coherent antenna ports. If the phase difference between any two antenna ports among multiple antenna ports is fixed, the multiple antenna ports are coherent. If the phase difference between any two antenna ports among multiple antenna ports is not fixed, the multiple antenna ports are non-coherent.

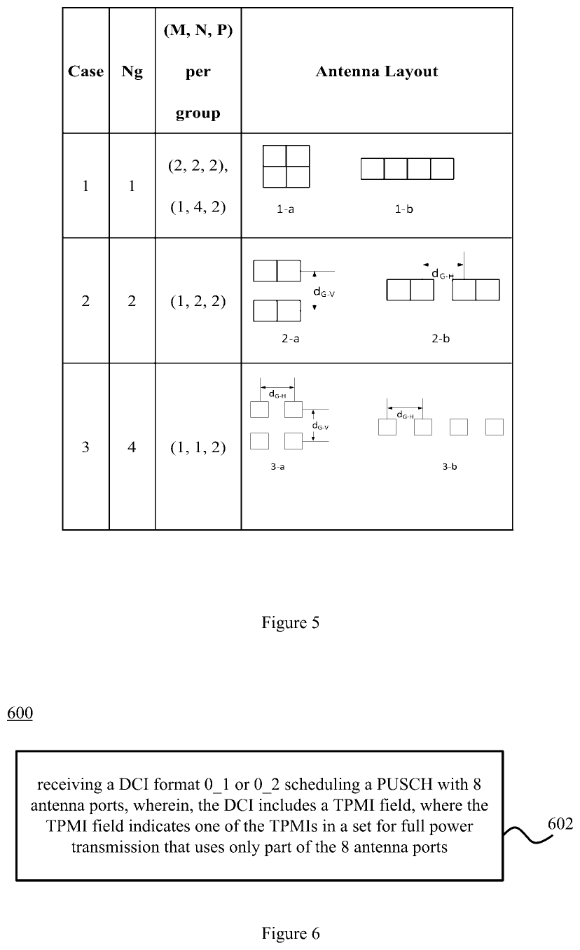

If a UE reports capability of partial-coherent or non-coherent with 8 antenna ports (i.e., PUSCH antenna port 1000, 1001, 1002, 1003, 1004, 1005, 1006 and 1007), only coherent antenna ports (where the coherent antenna ports are a part of the 8 antenna ports) can be used for transmission of one PUSCH layer. In particular, all 8 antenna ports are grouped as Ng antenna groups. All antenna ports within each antenna group are coherent, while antenna ports from different antenna groups are non-coherent. Several antenna layouts with different number of antenna groups are illustrated in FIG. 5.

In FIG. 5, Ng denotes the number of antenna groups. M denotes the number of antennas in vertical in an antenna group. N denotes the number of antennas in horizontal in an antenna group. P denotes the number of polarizations of each antenna. Each polarization of an antenna corresponds to an antenna port.

Antenna layout 1-a and antenna layout 1-b correspond to full coherent antenna array, i.e., all 8 antenna ports within each of antenna layout 1-a and antenna layout 1-b belong to one antenna group (e.g., antenna group #0, denoted as nNg=0) and are coherent antenna ports.

Antenna layout 2-a and antenna layout 2-b correspond to partial coherent antenna array with two antenna groups (Ng=2). For example, in each of antenna layout 2-a and antenna layout 2-b, each of antenna group #0 (a first antenna group, denoted as nNg=0) and antenna group #1 (a second antenna group, denoted as nNg=1) includes four coherent antenna ports.

Antenna layout 3-a and antenna layout 3-b correspond to partial coherent antenna array with four antenna groups (Ng=4). For example, in each of antenna layout 3-a and antenna layout 3-b, each of antenna group #0 (a first antenna group, denoted as nNg=0), antenna group #1 (a second antenna group, denoted as nNg=1), antenna group #2 (a third antenna group, denoted as nNg=2), and antenna group #3 (a fourth antenna group, denoted as nNg=3) includes two coherent antenna ports.

Before discussing the codebook design, the UE needs to report its antenna layout including the number of antenna groups 1≤Ng≤4, and optionally the antennas within each antenna group (M, N, P), where M indicates the number of antennas in horizontal, N indicates the number of antennas in vertical, P indicates the number of polarizations of each antenna. One polarization of each antenna corresponds to an antenna port. Each antenna group has the same antenna structure.

The UE can report the supported maxRank∈{1, 2, 3, 4, 5, 6, 7, 8}, i.e., the maximum number of PUSCH layers for a PUSCH transmission.

The gNB sends a DCI to the UE to schedule one or more PUSCH transmissions. The rank of the scheduled PUSCH transmission may be 1, 2, 3, 4, 5, 6, 7 or 8 depending on the reported maxRank. It means that the PUSCH transmission has L PUSCH layers, where L is equal to the rank, which is equal to or less than maxRank. A precoding matrix (which can also be referred to as precoder) shall be determined for the scheduled PUSCH transmission.

Incidentally, the number of columns of the precoding matrix indicates the number of layers of a PUSCH transmission for which the precoding matrix can be applied. So, precoding matrix (i.e., precoder) can be further described as rank R precoding matrix (precoder), e.g., rank 1 precoder, rank 2 precoder, rank 3 precoder, rank 4 precoder, rank 5 precoder, rank 6 precoder, rank 7 precoder, rank 8 precoder. Rank R precoding matrix (precoder) can be also denoted as R-layer precoding matrix (precoder), e.g., one-layer precoder (or single-layer precoder), two-layer precoder, three-layer precoder, four-layer precoder, five-layer precoder, six-layer precoder, seven-layer precoder, eight-layer precoder.

The number of rows of the precoding matrix (precoder) indicates the number of antenna ports for which the precoding matrix can be applied. For example, the precoding matrix (precoder) may have 2 or 4 or 8 rows (denoted as 2TX, 4TX, 8TX) for a UE with 2 antenna ports or 4 antenna ports or 8 antenna ports.

The maximal transmission powers of UEs are defined differently for different UE classes. In class 3 UE (Handheld UE), the maximal transmission power is 23 dBm. For a UE with 8 TX antenna ports each of which is associated with a power amplifier (PA), the maximal power of the PA for each TX antenna port can be the same or different. UEs can be classified into three types of capabilities based on the PA power of the 8 antenna ports. For Capability 1 UE, each PA can transmit with the maximal power of 23 dBm. For Capability 2 UE, each PA can only transmit with ⅛ of the maximal power, so each PA is rated only at 14 dBm. For Capability 3 UE, some antenna ports can transmit with power higher than 14 dBm, while the rest transmits only with 14 dBm. The transmission power of the antenna port can be represented by a backoff value (in unit of dB) from the maximal power (23 dBm) in Table 1.

TABLE 1

| | Transmission power the antenna ports |
|---|---|
| UE capability | relative to the maximal total power |
| 1 | [0, 0, 0, 0, 0, 0, 0, 0] |
| 2 | [−9, −9, −9, −9, −9, −9, −9, −9] |
| 3-1 | [−3, −9, −9, −9, −3, −9, −9, −9] |
| 3-2 | [−6, −6, −9, −9, −6, −6, −9, −9] |
| 3-3 | [−3, −9, −6, −9, −3, −9, −6, −9] |
| 3-4 | [−3, −9, −6, −7.8, −3, −9, −6, −7.8] |
| 3-5 | [−3, −7.8, −6, −7.8, −3, −7.8, −6, −7.8] |

As can be seen from Table 1, there are five different PA structures for Capability 3 UE, which are denoted as 3-1, 3-2, 3-3, 3-4 and 3-5. In each PA structure, each of the 8 values represents the backoff value of one of the 8 antenna ports. For example, the PA structure of Capability 3-4 UE is [−3, −9, −6, −7.8, −3, −9, −6, −7.8], where each of −3, −9, −6, −7.8, −3, −9, −6 and −7.8 represents the PA power of the PA associated with one of antenna ports 0 to 7 in sequence. That is, the PA power of the PA associated with antenna port 0 or 4 is −3 dB; the PA power of the PA associated with antenna port 1 or 5 is −9 dB; the PA power of the PA associated with antenna port 2 or 6 is −6 dB; and the PA power of the PA associated with antenna port 3 or 7 is −7.8 dB.

The backoff value −9 represents 23−9=14 dBm, which is equivalent to ⅛ of the maximal power (23 dBm) (that is, 10*lg ⅛)=−9); the backoff value −7.8 represents 23−7.8=16.2 dBm, which is equivalent to ⅙ of the maximal power (that is, 10*lg(⅙)=−7.8); the backoff value −6 represents 23−6=17 dBm, which is equivalent to ¼ of the maximal power (that is, 10*lg(¼)=−6); and the backoff value −3 represents 23−3=20 dBm, which is equivalent to ½ of the maximal power (that is, 10*lg (½)=−3).

A full coherent UE transmits using the DFT-based type 1 codebook. This insures that the full coherent UE can always transmit with full power, because all 8 antenna ports always transmit together. Even for a Capability 3 UE, transmitting using 8 antenna ports ensures full power uplink transmission, e.g., each of the 8 antenna ports can transmit with ⅛ of the maximal power (i.e., −9 dB or 14 dBm).

On the other hand, for a partial coherent 8TX UE (e.g., Ng=2 or Ng=4), all 8 antenna ports do not always transmit together. It means that, for a Capability 3 8TX UE (e.g., Ng=2 or Ng=4), full power uplink transmission may not be guaranteed with conventional agreed precoders, especially, for the agreed precoders in which only part of the 8 antenna ports are used to transmit.

This disclosure proposes solutions for full power uplink transmission for Capability 3 8TX UE.

The current agreement on regular transmission mode defines a precoding structure as follows: these precoders have a two stage hierarchical structure, although the final table of TPMI may incorporate all the entries into a single table.

A partial coherent 8TX UE with Ng=2 has 2 coherent antenna groups, where each of the 2 coherent antenna groups includes four coherent antenna ports.

In a first stage, for rank N (where N is from 1 to 8) transmission, the N data layer(s) (where “data layer” may be abbreviated as “layer” hereinafter) are split between the two antenna groups, where N₁ (0<=N₁<=N) layer(s) are transmitted from the first antenna group, and N₂ (0<=N2<=N) layer(s) are transmitted from the second antenna group, and N₁+N₂=N. A same layer is transmitted only from one of the antenna groups. Each (N₁, N₂) can be referred to as a layer scheme (or layer split). The agreed possible layer schemes (i.e., layer splits) for 8TX UE with Ng=2 are given in Table 2. Those schemes that utilize all 2 antenna groups (i.e., utilize all 8 antenna ports, thus can reach full power) are underlined.

TABLE 2

| | Layer splits in which | |
|---|---|---|
| | all layers in one | Layer splits across 2 |
| Rank | Antenna Group | Antenna Groups |
| 1 | (1, 0), (0, 1) | |
| 2 | (2, 0), (0, 2) | |
| 2 | | (1, 1) |
| 3 | (3, 0), (0, 3) | |
| 3 | | (1, 2), (2, 1) |
| 4 | (4, 0), (0, 4) | |
| 4 | | (2, 2) |
| 5 | | [(2, 3), (3, 2)] |
| 6 | | (3, 3) |
| 7 | | [(3, 4), (4, 3)] |
| 8 | | (4, 4) |

After the number of layers (N₁ or N₂) is determined in each antenna group, a full coherent precoder of 4TX from the NR Release 15 codebooks (selected from indices 12-27 of Table 6.3.1.5-2, indices 12-27 of Table 6.3.1.5-3, indices 14-21 of Table 6.3.1.5-5, indices 3-6 of Table 6.3.1.5-6, or indices 3-4 of Table 6.3.1.5-7 (they are shown in the Appendix) depending on the rank and waveform) is chosen for the antenna group.

A partial coherent 8TX UE with Ng=4 has 4 coherent antenna groups, where each of the 4 coherent antenna groups includes two coherent antenna ports.

The agreed layer schemes (layer splits) for partial coherent 8TX UE with Ng=4 are shown in Table 3. Those schemes that utilize all 4 antenna groups (i.e., utilize all 8 antenna ports, thus can reach full power) are underlined.

TABLE 3

| | Layer splits in | Layer splits across 4 Antenna |
|---|---|---|
| | which all layers in | Groups (All possible |
| Rank | one Antenna Group | permutations) |
| 1 | (1, 0, 0, 0), | |
| | (0, 1, 0, 0), | |
| | (0, 0, 1, 0), | |
| | (0, 0, 0, 1) | |
| 2 | (2, 0, 0, 0), | |
| | (0, 2, 0, 0), | |
| | (0, 0, 2, 0), | |
| | (0, 0, 0, 2) | |
| 2 | | Transmission by 2 of the 4 antenna groups: |
| | | (1, 1, 0, 0), (1, 0, 1, 0), (1, 0, 0, 1) |
| | | (0, 1, 1, 0), (0, 1, 0, 1), (0, 0, 1, 1) |
| 3 | | Transmission by 2 of the 4 antenna groups: |
| | | (2, 1, 0, 0), (2, 0, 1, 0), (2, 0, 0, 1), |
| | | (0, 2, 1, 0), (0, 2, 0, 1), (0, 0, 2, 1), |
| | | Transmission by 3 of the 4 antenna groups: |
| | | (1, 1, 1, 0), (1, 1, 0, 1), (1, 0, 1, 1), |
| | | (0, 1, 1, 1) |
| 4 | | (1, 1, 1, 1) |
| 4 | | Transmission by 2 of the 4 antenna groups: |
| | | (2, 2, 0, 0), (2, 0, 2, 0), (2, 0, 0, 2) |
| | | (0, 2, 2, 0), (0, 2, 0, 2), (0, 0, 2, 2) |
| 5 | | Transmission by 3 of the antenna groups: |
| | | (2, 0, 2, 1), (0, 2, 2, 1), |
| | | Transmission by 4 of the 4 antenna groups: |
| | | (1, 1, 2, 1) |
| 6 | | Transmission by 3 of the 4 antenna groups: |
| | | (2, 2, 2, 0), (2, 0, 2, 2) |
| | | Transmission by 4 of the 4 antenna groups: |
| | | (2, 1, 2, 1) |
| 7 | | Transmission by 4 of the 4 antenna groups: |
| | | (2, 1, 2, 2) |
| 8 | | (2, 2, 2, 2) |

After the number of layers is determined in each of the four coherent antenna groups, a full coherent precoder of 2TX from the NR Release 15 codebooks (selected from indices 2-5 of Table 6.3.1.5-1, or indices 1-2 of Table 6.3.1.5-4 (they are shown in the Appendix) depending on the rank) is chosen for the antenna group.

The solutions for full power transmission are different for Ng=2 and Ng=4, and are different for different PA structures. For each PA structure for Ng=2 or Ng=4, a subset G (e.g., G0, G1, G2, G3, G4) of layer splits (where the layer splits do not use all 8 antenna ports to transmit) is identified that can be used for full power transmission. This disclosure does not make any change to the selection of a codebook from Table 6.3.1.5-2, Table 6.3.1.5-3, Table 6.3.1.5-5, Table 6.3.1.5-6, Table 6.3.1.5-7 depending on the rank and waveform or the selection of a codebook from Table 6.3.1.5-1, Table 6.3.1.5-4 depending on the rank.

A first embodiment relates to partial coherent Capability 3 (e.g., 3-1 to 3-5) 8TX UE with Ng=2.

For a Capability 3 8TX UE, because all the antenna ports have PAs each with at least ⅛ of the maximal power (i.e., equal to or larger than-9 dB relative to the maximal power), if all 8 antenna ports are used to transmit, full power can be naturally reached. On the other hand, as can be seen from Table 2, for some agreed layer splits in which only one antenna group is used to transmit, full power transmission cannot be guaranteed.

According to the first embodiment, a subset of layer splits that can be used for full power transmission for Capability 3 8TX UE with Ng=2 is identified.

As shown in Table 1, a Capability 3 8TX UE may have five different PA structures denoted as capabilities 3-1 to 3-5. That is,
Capability 3-1: [−3, −9, −9, −9, −3, −9, −9, −9]
Capability 3-2: [−6, −6, −9, −9, −6, −6, −9, −9]
Capability 3-3: [−3, −9, −6, −9, −3, −9, −6, −9]
Capability 3-4: [−3, −9, −6, −7.8, −3, −9, −6, −7.8]
Capability 3-5: [−3, −7.8, −6, −7.8, −3, −7.8, −6, −7.8]

A first sub-embodiment of the first embodiment relates to a Capability 3-2 8TX UE with the PA structure of [−6, −6, −9, −9, −6, −6, −9, −9].

It can be seen that the four PAs with power −6 dB from full power (i.e., 17 dBm) are arranged in a same antenna group. Without loss of generality, the four PAs with power-6 dB are arranged in the first antenna group including antenna ports 0, 1, 4, 5 while the four PAs with power −9 dB are arranged in the second antenna group including antenna ports 2, 3, 6, 7.

So, if only the first antenna group including antenna ports 0, 1, 4, 5 each of which is arranged with a PA with power −6 dB is used for transmission and a full coherent 4TX precoder (selected from indices 12-27 of Table 6.3.1.5-2, indices 12-27 of Table 6.3.1.5-3, indices 14-21 of Table 6.3.1.5-5, indices 3-6 of Table 6.3.1.5-6, or indices 3-4 of Table 6.3.1.5-7 according to the rank and waveform) is used for the first antenna group, the layer splits that can reach full power are underlined in Table 4.

TABLE 4

| | Layer splits in which | | |
|---|---|---|---|
| | all layers in one | Layer splits across 2 | |
| Rank | Antenna Group | Antenna Groups | G0 |
| 1 | (1, 0), (0, 1) | — | (1, 0) |
| 2 | (2, 0), (0, 2) | — | (2, 0) |
| 2 | — | (1, 1) | |
| 3 | (3, 0), (0, 3) | — | (3, 0) |
| 3 | — | (1, 2), (2, 1) | |
| 4 | (4, 0), (0, 4) | — | (4, 0) |
| 4 | — | (2, 2) | |
| 5 | — | [(2, 3), (3, 2)] | |
| 6 | — | (3, 3) | |
| 7 | — | [(3, 4), (4, 3)] | |
| 8 | — | (4, 4) | |

A comparison between Table 2 and Table 4 can reveal that the layer splits (1, 0), (2, 0), (3, 0) and (4, 0) are also underlined in Table 4. It means that, for these layer splits (1, 0), (2, 0), (3, 0) and (4, 0), each of the four antenna ports 0, 1, 4, 5 in the first antenna group can use a PA with power −6 dB (i.e., ¼ of the maximum power 23 dBm) according to the PA structure [−6, −6, −9, −9, −6, −6, −9, −9], so that 0 dB (i.e., the maximum power 23 dBm) can be reached by only using the first antenna group to transmit.

The layer splits (1, 0), (2, 0), (3, 0) and (4, 0) are denoted as G0 in the added fourth column in Table 4. That is, G0={(1, 0), (2, 0), (3, 0), (4, 0)} indicates a subset of layer splits (where the layer splits do not use all 8 antenna ports to transmit) that can be used for full power transmission. In particular, as shown in Table 2 or 4, {(1, 0), (0, 1), (2, 0), (0, 2), (3, 0), (0, 3), (4, 0), (0, 4)} are the layer splits that do not use all 8 antenna ports to transmit. The layer splits that uses all 8 antenna ports to transmit, which can naturally reach full power, are not included in G0.

A second sub-embodiment of the first embodiment relates to a Capability 3-1 8TX UE with the PA structure of [−3, −9, −9, −9, −3, −9, −9, −9].

Based on the analysis of the first sub-embodiment, if only one antenna group is used to transmit, to reach full power (i.e., 23 dBm), the PA of each of four antenna ports in the one antenna group shall be at least (i.e., equal to or larger than) −6 dB. However, for the PA structure of [−3, −9, −9, −9, −3, −9, −9, −9], the PA powers of only two PAs are larger than −6 dB. So, it is impossible to find layer splits (that do not use all 8 antenna ports to transmit, e.g., only use the first antenna group to transmit) that can be used for full power for the PA structure of [−3, −9, −9, −9, −3, −9, −9, −9] (Capability 3-1) for 8TX UE with Ng=2.

A third sub-embodiment of the first embodiment relates to a Capability 3-3 8TX UE with the TA structure of [−3, −9, −6, −9, −3, −9, −6, −9], a Capability 3-4 8TX UE with the TA structure of [−3, −9, −6, −7.8, −3, −9, −6, −7.8], and a Capability 3-5 8TX UE with the TA structure of [−3, −7.8, −6, −7.8, −3, −7.8, −6, −7.8].

Different from the Capability 3-1 8TX UE with the TA structure of [−9, −9, −9, −9, −9, −9, −3, −3], for each of the Capability 3-3 8TX UE with the TA structure of [−3, −9, −6, −9, −3, −9, −6, −9], the Capability 3-4 8TX UE with the TA structure of [−3, −9, −6, −7.8, −3, −9, −6, −7.8], and the Capability 3-5 8TX UE with the TA structure of [−3, −7.8, −6, −7.8, −3, −7.8, −6, −7.8], the PA powers of four PAs are equal to or larger than −6 dB. So, it is possible to find layer splits (that do not use all 8 antenna ports to transmit) that can be used for full power.

In particular, if the four PAs with power of at least −6 dB (e.g., −3 dB and −6 dB) are arranged in the first antenna group including antenna ports 0, 1, 4, 5 while the four PAS with power lower than −6 dB (e.g., −9 dB and −7.8 dB) are arranged in the second antenna group including antenna ports 2, 3, 6, 7, G0={(1, 0), (2, 0), (3, 0), (4, 0)} can be similarly obtained.

As a whole, according to the first embodiment, the layer splits in each of which only one antenna group (i.e., four antenna ports included in the one antenna group, that are part of the eight antenna ports) is used to transmit to reach full power are chosen as a subset (e.g., G0) of layer splits (where the layer splits use part of the 8 antenna ports (do not use all 8 antenna ports) to transmit).

Incidentally, the first embodiment chooses only the first antenna group to transmit to reach full power. The first antenna group can be regarded a predetermined antenna group. It is possible that the second antenna group is the predetermined antenna group. For example, if the PA structure for Capability 3-2 is changed to [−9, −9, −6, −6, −9, −9, −6, −6], the second antenna group is the predetermined antenna group.

A second embodiment relates to partial coherent Capability 3 (e.g., 3-1 to 3-5) 8TX UE with Ng=4.

Similar to Ng=2, for a Capability 3 8TX UE with Ng=4, because all the antenna ports have PAs each with at least ⅛ of the maximal power (i.e., equal to or larger than −9 dB relative to the maximal power), if all 8 antenna ports are used to transmit, full power can be naturally reached. On the other hand, as can be seen from Table 3, for some agreed layer splits (i.e., only one or two or three antenna groups are used to transmit), full power transmission cannot be guaranteed.

According to the second embodiment, a subset of layer splits that can be used for full power transmission for Capability 3 8TX UE with Ng=4 is identified.

A first sub-embodiment of the second embodiment relates to a Capability 3-1 8TX UE with transmission power of [−3, −9, −9, −9, −3, −9, −9, −9].

The two PAs with power −3 dB from full power (i.e., 20 dBm) are arranged in a same antenna group. Without loss of generality, the two PAs with power −3 dB are arranged in the first antenna group including antenna ports 0, 4, while the other six PAs with power −9 dB are arranged in the second antenna group including antenna ports 1, 5, the third antenna group including antenna ports 2, 6 and the fourth antenna group including antenna ports 3, 7.

So, if only the first antenna group including antenna ports 0, 4 each of which is arranged with a PA with power −3 dB is used to transmit and a full coherent 4TX precoder (selected from Table 6.2.1.5-1, or Table 6.2.1.5-4 according to the rank) is used for the first antenna group, the layer splits that can reach full power are underlined in Table 5.

TABLE 5

| | | Layers split across 4 Antenna | |
|---|---|---|---|
| | All layers in one | Groups | |
| Rank | Antenna Group | (All possible permutations) | G1 |
| 1 | (1, 0, 0, 0), | | (1, 0, 0, 0) |
| | (0, 1, 0, 0), | | |
| | (0, 0, 1, 0), | | |
| | (0, 0, 0, 1) | | |
| 2 | (2, 0, 0, 0), | | (2, 0, 0, 0) |
| | (0, 2, 0, 0), | | |
| | (0, 0, 2, 0), | | |
| | (0, 0, 0, 2) | | |
| 2 | | Transmission by 2 of the 4 | |
| | | antenna groups: | |
| | | (1, 1, 0, 0), (1, 0, 1, 0), (1, 0, 0, 1) | |
| | | (0, 1, 1, 0), (0, 1, 0, 1), (0, 0, 1, 1) | |
| 3 | | Transmission by 2 of the 4 | |
| | | antenna groups: | |
| | | (2, 1, 0, 0), (2, 0, 1, 0), (2, 0, 0, 1), | |
| | | (0, 2, 1, 0), (0, 2, 0, 1), (0, 0, 2, 1), | |
| | | Transmission by 3 of the 4 | |
| | | antenna groups: | |
| | | (1, 1, 1, 0), (1, 1, 0, 1), (1, 0, 1, 1), | |
| | | (0, 1, 1, 1) | |
| 4 | | (1, 1, 1, 1) | |
| 4 | | Transmission by 2 of the 4 | |
| | | antenna groups: | |
| | | (2, 2, 0, 0), (2, 0, 2, 0), (2, 0, 0, 2) | |
| | | (0, 2, 2, 0), (0, 2, 0, 2), (0, 0, 2, 2) | |
| 5 | | Transmission by 3 of the | |
| | | antenna groups: | |
| | | (2, 0, 2, 1), (0, 2, 2, 1), | |
| | | Transmission by 4 of the 4 | |
| | | antenna groups: | |
| | | (1, 1, 2, 1) | |
| 6 | | Transmission by 3 of the 4 | |
| | | antenna groups: | |
| | | (2, 2, 2, 0), (2, 0, 2, 2) | |
| | | Transmission by 4 of the 4 | |
| | | antenna groups: | |
| | | (2, 1, 2, 1) | |
| 7 | | Transmission by 4 of the 4 | |
| | | antenna groups: | |
| | | (2, 1, 2, 2) | |
| 8 | | (2, 2, 2, 2) | |

A comparison between Table 3 and Table 5 can reveal that the layer splits (1, 0, 0, 0) and (2, 0, 0, 0) are also underlined in Table 5. It means that, for these layer splits (1, 0, 0, 0) and (2, 0, 0, 0), each of the two antenna ports 0, 4 in the first antenna group can use a PA with power −3 dB (i.e., ½ of the maximum power 23 dBm) according to the PA structure [−3, −9, −9, −9, −3, −9, −9, −9], so that 0 dB (i.e., the maximum power 23 dBm) can be reached by only using the first antenna group to transmit.

The layer splits (1, 0, 0, 0) and (2, 0, 0, 0) are denoted as G1 in the added fourth column in Table 5. That is, G1={(1, 0, 0, 0), (2, 0, 0, 0)} indicates a subset (G1) of layer splits (where the layer splits do not use all 8 antenna ports to transmit) that can be used for full power transmission. The layer splits that uses all 8 antenna ports to transmit, which can naturally reach full power, are not included in G1.

Incidentally, due to the fact that, among the agreed layer splits for Rank 3, there is no layer split in which only one antenna group (e.g., the first antenna group) is used to transmit, transmission with full power is not supported for rank 3.

A second sub-embodiment of the second embodiment relates to a Capability 3-2 8TX UE with the PA structure of [−6, −6, −9, −9, −6, −6, −9, −9].

Based on the analysis of the first sub-embodiment, if only one antenna group is used to transmit, to reach full power (i.e., 23 dBm), the power of PA of each of two antenna ports in the one antenna group shall be at least (i.e., equal to or larger than) −3 dB. However, for the Capability 3-2, there is no PA power that is equal to or larger than −3 dB. So, it is impossible to find layer splits (that do not use all 8 antenna ports to transmit) that can be used for full power for the PA structure of [−6, −6, −9, −9, −6, −6, −9, −9] (Capability 3-2) for 8TX UE with Ng=4.

A third sub-embodiment of the second embodiment relates to a Capability 3-3 8TX UE with the TA structure of [−3, −9, −6, −9, −3, −9, −6, −9].

The two PAs with power −3 dB from full power (i.e., 20 dBm) are arranged in a same antenna group, and two PAs with power −6 dB from full power (i.e., 17 dBm) are arranged in another same antenna group. Without loss of generality, the two PAs with power −3 dB are arranged in the first antenna group including antenna ports 0, 4, and the two PAs with power −6 dB are arranged in the third antenna group including antenna ports 2, 6, while the other four PAs with power −9 dB are arranged in the second antenna group including antenna ports 1, 5 and the fourth antenna group including antenna ports 3, 7.

The layer splits that can reach full power are underlined in Table 6.

TABLE 6

| | | Layer splits across 4 Antenna | |
|---|---|---|---|
| | All layers in one | Groups | |
| Rank | Antenna Group | (All possible permutations) | G2 |
| 1 | (1, 0, 0, 0), | | (1, 0, 0, 0) |
| | (0, 1, 0, 0), | | |
| | (0, 0, 1, 0), | | |
| | (0, 0, 0, 1) | | |
| 2 | (2, 0, 0, 0), | | (2, 0, 0, 0) |
| | (0, 2, 0, 0), | | |
| | (0, 0, 2, 0), | | |
| | (0, 0, 0, 2) | | |
| 2 | | Transmission by 2 of the 4 | (1, 0, 1, 0) |
| | | antenna groups: | |
| | | (1, 1, 0, 0), (1, 0, 1, 0), (1, 0, 0, 1) | |
| | | (0, 1, 1, 0), (0, 1, 0, 1), (0, 0, 1, 1) | |
| 3 | | Transmission by 2 of the 4 | (2, 0, 1, 0) |
| | | antenna groups: | |
| | | (2, 1, 0, 0), (2, 0, 1, 0), (2, 0, 0, 1), | |
| | | (0, 2, 1, 0), (0, 2, 0, 1), (0, 0, 2, 1), | |
| | | Transmission by 3 of the 4 | |
| | | antenna groups: | |
| | | (1, 1, 1, 0), (1, 1, 0, 1), (1, 0, 1, 1), | |
| | | (0, 1, 1, 1) | |
| 4 | | (1, 1, 1, 1) | |
| 4 | | Transmission by 2 of the 4 | (2, 0, 2, 0) |
| | | antenna groups: | |
| | | (2, 2, 0, 0), (2, 0, 2, 0), (2, 0, 0, 2) | |
| | | (0, 2, 2, 0), (0, 2, 0, 2), (0, 0, 2, 2) | |
| 5 | | Transmission by 3 of the | |
| | | antenna groups: | |
| | | (2, 0, 2, 1), (0, 2, 2, 1), | |
| | | Transmission by 4 of the 4 | |
| | | antenna groups: | |
| | | (1, 1, 2, 1) | |
| 6 | | Transmission by 3 of the 4 | |
| | | antenna groups: | |
| | | (2, 2, 2, 0), (2, 0, 2, 2) | |
| | | Transmission by 4 of the 4 | |
| | | antenna groups: | |
| | | (2, 1, 2, 1) | |
| 7 | | Transmission by 4 of the 4 | |
| | | antenna groups: | |
| | | (2, 1, 2, 2) | |
| 8 | | (2, 2, 2, 2) | |

A comparison between Table 3 and Table 6 can reveal that the layer splits (1, 0, 0, 0), (2, 0, 0, 0), (1, 0, 1, 0), (2, 0, 1, 0) and (2, 0, 2, 0) are also underlined in Table 6. It means that, for the layer splits (1, 0, 0, 0) and (2, 0, 0, 0), each of the two antenna ports 0, 4 in the first antenna group can use a PA with power −3 dB (i.e., ½ of the maximum power 23 dBm) according to the PA structure [−3, −9, −6, −9, −3, −9, −6, −9], so that 0 dB (i.e., the maximum power 23 dBm) can be reached by only using the first antenna group to transmit; and that, for the layer splits (1, 0, 1, 0), (2, 0, 1, 0) and (2, 0, 2, 0), each of the two antenna ports 0, 4 in the first antenna group and each of the two antenna ports 2, 6 in the third antenna group can use a PA with power −6 dB (i.e., ¼ of the maximum power 23 dBm) according to the PA structure [−3, −9, −6, −9, −3, −9, −6, −9], so that 0 dB (i.e., the maximum power 23 dBm) can be reached by only using the first and the third antenna groups to transmit.

Incidentally, although a layer split in which the first, the second and the third antenna groups are used to transmit (e.g., (1, 1, 1, 0)) that utilizes the PAs with (−3, −3, −9, −9, −6, −6) dB can, in theory, transmit with full power, for example, by using power (−6, −6, −9, −9, −9, −9) dB, it is not preferable to do so. This is because it gives the layer transmitted from the first antenna group twice the power as the layers transmitted from the second and the third antenna groups. This will lead to significant imbalance RX power (and SINR) at the receiver, and make it difficult to decode the codeword.

The layer splits (1, 0, 0, 0), (2, 0, 0, 0), (1, 0, 1, 0), (2, 0, 1, 0) and (2, 0, 2, 0) are denoted as G2 in the added fourth column in Table 6. That is, G2={(1, 0, 0, 0), (2, 0, 0, 0), (1, 0, 1, 0), (2, 0, 1, 0), (2, 0, 2, 0)} indicates a subset of layer splits (where the layer splits do not use all 8 antenna ports to transmit) that can be used for full power transmission. The layer splits that uses all 8 antenna ports to transmit, which can naturally reach full power, are not included in G2.

A fourth sub-embodiment of the second embodiment relates to a Capability 3-4 8TX UE with the TA structure of [−3, −9, −6, −7.8, −3, −9, −6, −7.8].

Each pair of PAs with the same power are arranged in a same antenna group. Without loss of generality, the two PAs with power −3 dB are arranged in the first antenna group including antenna ports 0, 4; the two PAs with power −6 dB are arranged in the third antenna group including antenna ports 2, 6; the two PAs with power −7.8 dB are arranged in the fourth antenna group including antenna ports 3, 7; and the two PAs with power −9 dB are arranged in the second antenna group including antenna ports 1, 5.

The layer splits that can reach full power are underlined in Table 7.

TABLE 7

| | | Layer splits across 4 Antenna | |
|---|---|---|---|
| | All layers in one | Groups | |
| Rank | Antenna Group | (All possible permutations) | G3 |
| 1 | (1, 0, 0, 0), | | (1, 0, 0, 0) |
| | (0, 1, 0, 0), | | |
| | (0, 0, 1, 0), | | |
| | (0, 0, 0, 1) | | |
| 2 | (2, 0, 0, 0), | | (2, 0, 0, 0) |
| | (0, 2, 0, 0), | | |
| | (0, 0, 2, 0), | | |
| | (0, 0, 0, 2) | | |
| 2 | | Transmission by 2 of the 4 | (1, 0, 1, 0) |
| | | antenna groups: | |
| | | (1, 1, 0, 0), (1, 0, 1, 0), (1, 0, 0, 1) | |
| | | (0, 1, 1, 0), (0, 1, 0, 1), (0, 0, 1, 1) | |
| 3 | | Transmission by 2 of the 4 | (2, 0, 1, 0) |
| | | antenna groups: | |
| | | (2, 1, 0, 0), (2, 0, 1, 0), (2, 0, 0, 1), | |
| | | (0, 2, 1, 0), (0, 2, 0, 1), (0, 0, 2, 1), | |
| | | Transmission by 3 of the 4 | |
| | | antenna groups: | |
| | | (1, 1, 1, 0), (1, 1, 0, 1), (1, 0, 1, 1), | (1, 0, 1, 1) |
| | | (0, 1, 1, 1) | |
| 4 | | (1, 1, 1, 1) | |
| 4 | | Transmission by 2 of the 4 | (2, 0, 2, 0) |
| | | antenna groups: | |
| | | (2, 2, 0, 0), (2, 0, 2, 0), (2, 0, 0, 2) | |
| | | (0, 2, 2, 0), (0, 2, 0, 2), (0, 0, 2, 2) | |
| 5 | | Transmission by 3 of the | (2, 0, 2, 1) |
| | | antenna groups: | |
| | | (2, 0, 2, 1), (0, 2, 2, 1), | |
| | | Transmission by 4 of the 4 | |
| | | antenna groups: | |
| | | (1, 1, 2, 1) | |
| 6 | | Transmission by 3 of the 4 | (2, 0, 2, 2) |
| | | antenna groups: | |
| | | (2, 2, 2, 0), (2, 0, 2, 2) | |
| | | Transmission by 4 of the 4 | |
| | | antenna groups: | |
| | | (2, 1, 2, 1) | |
| 7 | | Transmission by 4 of the 4 | |
| | | antenna groups: | |
| | | (2, 1, 2, 2) | |
| 8 | | (2, 2, 2, 2) | |

A comparison between Table 3 and Table 7 can reveal that the layer splits (1, 0, 0, 0), (2, 0, 0, 0), (1, 0, 1, 0), (2, 0, 1, 0), (1, 0, 1, 1), (2, 0, 2, 0), (2, 0, 2, 1), (2, 0, 2, 2) are also underlined in Table 7. It means that, for the layer splits (1, 0, 0, 0) and (2, 0, 0, 0), each of the two antenna ports 0, 4 in the first antenna group can use a PA with power −3 dB (i.e., ½ of the maximum power 23 dBm) according to the PA structure [−3, −9, −6, −7.8, −3, −9, −6, −7.8], so that 0 dB (i.e., the maximum power 23 dBm) can be reached by only using the first antenna group to transmit;

that, for the layer splits (1, 0, 1, 0), (2, 0, 1, 0) and (2, 0, 2, 0), each of the two antenna ports 0, 4 in the first antenna group and the each of the two antenna ports 2, 6 in the third antenna group can use a PA with power −6 dB (i.e., ¼ of the maximum power 23 dBm) according to the PA structure [−3, −9, −6, −7.8, −3, −9, −6, −7.8], so that 0 dB (i.e., the maximum power 23 dBm) can be reached by only using the first and the third antenna groups to transmit; and that for the layer splits (1, 0, 1, 1), (2, 0, 2, 1) and (2, 0, 2, 2), each of the two antenna ports 0, 4 in the first antenna group, each of the two antenna ports 2, 6 in the third antenna group and each of two antenna ports 3, 7 in the fourth antenna group can use a PA with power −7.8 dB (i.e., ⅙ of the maximum power 23 dBm) according to the PA structure [−3, −9, −6, −7.8, −3, −9, −6, −7.8], so that 0 dB (i.e., the maximum power 23 dBm) can be reached by only using the first, the third and the fourth antenna groups to transmit.

The layer splits (1, 0, 0, 0), (2, 0, 0, 0), (1, 0, 1, 0), (2, 0, 1, 0), (1, 0, 1, 1), (2, 0, 2, 0), (2, 0, 2, 1), (2, 0, 2, 2) are denoted as G3 in the added fourth column in Table 7. That is, G3={(1, 0, 0, 0), (2, 0, 0, 0), (1, 0, 1, 0), (2, 0, 1, 0), (1, 0, 1, 1), (2, 0, 2, 0), (2, 0, 2, 1), (2, 0, 2, 2)} indicates a subset of layer splits (where the layer splits do not use all 8 antenna ports to transmit) that can be used for full power transmission. The layer splits that uses all 8 antenna ports to transmit, which can naturally reach full power, are not included in G3.

A fifth sub-embodiment of the second embodiment relates to a Capability 3-5 8TX UE with the TA structure of [−3, −7.8, −6, −7.8, −3, −7.8, −6, −7.8].

The two PAs with power −3 dB from full power (i.e., 20 dBm) can be arranged in a same antenna group, and two PAs with power −6 dB from full power (i.e., 17 dBm) can be arranged in another same antenna group. Without loss of generality, the two PAs with power −3 dB are arranged in the first antenna group including antenna ports 0, 4, and the two PAs with power −6 dB are arranged in the third antenna group including antenna ports 2, 6, while the other four PAs with power −7.8 dB are arranged in the second antenna group including antenna ports 1, 5 and the fourth antenna group including antenna ports 3, 7.

The layer splits that can reach full power are underlined in Table 8.

TABLE 8

| | | Layer split across 4 Antenna | |
|---|---|---|---|
| | All layers in one | Groups | |
| Rank | Antenna Group | (All possible permutations) | G4 |
| 1 | (1, 0, 0, 0), (0, 1, 0, 0), | | (1, 0, 0, 0) |
| | (0, 0, 1, 0), (0, 0, 0, 1) | | |
| 2 | (2, 0, 0, 0), (0, 2, 0, 0), | | (2, 0, 0, 0) |
| | (0, 0, 2, 0), (0, 0, 0, 2) | | |
| 2 | | Transmission by 2 of the 4 | (1, 0, 1, 0) |
| | | antenna groups: | |
| | | (1, 1, 0, 0), (1, 0, 1, 0), (1, 0, 0, 1) | |
| | | (0, 1, 1, 0), (0, 1, 0, 1), (0, 0, 1, 1) | |
| 3 | | Transmission by 2 of the 4 | (2, 0, 1, 0) |
| | | antenna groups: | |
| | | (2, 1, 0, 0), (2, 0, 1, 0), (2, 0, 0, 1), | |
| | | (0, 2, 1, 0), (0, 2, 0, 1), (0, 0, 2, 1), | |
| | | Transmission by 3 of the 4 | |
| | | antenna groups: | |
| | | (1, 1, 1, 0), (1, 1, 0, 1), (1, 0, 1, 1), | (1, 1, 1, 0), (1, 1, 0, 1), (1, 0, 1, 1), |
| | | (0, 1, 1, 1) | (0, 1, 1, 1) |
| 4 | | (1, 1, 1, 1) | |
| 4 | | Transmission by 2 of the 4 | (2, 0, 2, 0) |
| | | antenna groups: | |
| | | (2, 2, 0, 0), (2, 0, 2, 0), (2, 0, 0, 2) | |
| | | (0, 2, 2, 0), (0, 2, 0, 2), (0, 0, 2, 2) | |
| 5 | | Transmission by 3 of the | (2, 0, 2, 1), (0, 2, 2, 1) |
| | | antenna groups: | |
| | | (2, 0, 2, 1), (0, 2, 2, 1), | |
| | | Transmission by 4 of the 4 | |
| | | antenna groups: | |
| | | (1, 1, 2, 1) | |
| 6 | | Transmission by 3 of the 4 | (2, 2, 2, 0), (2, 0, 2, 2) |
| | | antenna groups: | |
| | | (2, 2, 2, 0), (2, 0, 2, 2) | |
| | | Transmission by 4 of the 4 | |
| | | antenna groups: | |
| | | (2, 1, 2, 1) | |
| 7 | | Transmission by 4 of the 4 | |
| | | antenna groups: | |
| | | (2, 1, 2, 2) | |
| 8 | | (2, 2, 2, 2) | |

A comparison between Table 3 and Table 8 can reveal that the layer splits (1, 0, 0, 0), (2, 0, 0, 0), (1, 0, 1, 0), (2, 0, 1, 0), (1, 1, 1, 0), (1, 1, 0, 1), (1, 0, 1, 1), (0, 1, 1, 1), (2, 0, 2, 0), (2, 0, 2, 1), (0, 2, 2, 1), (2, 2, 2, 0) and (2, 0, 2, 2) are also underlined in Table 8. It means
that, for the layer splits (1, 0, 0, 0) and (2, 0, 0, 0), each of the two antenna ports 0, 4 in the first antenna group can use a PA with power −3 dB (i.e., ½ of the maximum power 23 dBm) according to the PA structure [−3, −7.8, −6, −7.8, −3, −7.8, −6, −7.8], so that 0 dB (i.e., the maximum power 23 dBm) can be reached by only using the first antenna group to transmit;
that, for the layer splits (1, 0, 1, 0), (2, 0, 1, 0) and (2, 0, 2, 0), each of the two antenna ports 0, 4 in the first antenna group and the each of the two antenna ports 2, 6 in the third antenna group can use a PA with power −6 dB (i.e., ¼ of the maximum power 23 dBm) according to the PA structure [−3, −7.8, −6, −7.8, −3, −7.8, −6, −7.8], so that 0 dB (i.e., the maximum power 23 dBm) can be reached by only using the first and the third antenna groups to transmit;
that, for the layer splits (1, 1, 1, 0) and (2, 2, 2, 0), each of the two antenna ports 0, 4 in the first antenna group, each of two antenna ports 1, 5 in the second antenna group and each of the two antenna ports 2, 6 in the third antenna group can use a PA with power −7.8 dB (i.e., ⅙ of the maximum power 23 dBm) according to the PA structure [−3, −7.8, −6, −7.8, −3, −7.8, −6, −7.8], so that 0 dB (i.e., the maximum power 23 dBm) can be reached by only using the first, the second and the third antenna groups to transmit;
that, for the layer split (1, 1, 0, 1), each of the two antenna ports 0, 4 in the first antenna group, each of two antenna ports 1, 5 in the second antenna group and each of the two antenna ports 3, 7 in the fourth antenna group can use a PA with power −7.8 dB (i.e., ⅙ of the maximum power 23 dBm) according to the PA structure [−3, −7.8, −6, −7.8, −3, −7.8, −6, −7.8], so that 0 dB (i.e., the maximum power 23 dBm) can be reached by only using the first, the second and the fourth antenna groups to transmit;
that, for the layer splits (1, 0, 1, 1), (2, 0, 2, 1) and (2, 0, 2, 2), each of the two antenna ports 0, 4 in the first antenna group, each of the two antenna ports 2, 6 in the third antenna group and each of two antenna ports 3, 7 in the fourth antenna group can use a PA with power −7.8 dB (i.e., ⅙ of the maximum power 23 dBm) according to the PA structure [−3, −7.8, −6, −7.8, −3, −7.8, −6, −7.8], so that 0 dB (i.e., the maximum power 23 dBm) can be reached by only using the first, the third and the fourth antenna groups to transmit; and
that, for the layer splits (0, 1, 1, 1) and (0, 2, 2, 1), each of the two antenna ports 1, 5 in the second antenna group, each of the two antenna ports 2, 6 in the third antenna group and each of two antenna ports 3, 7 in the fourth antenna group can use a PA with power −7.8 dB (i.e., ⅙ of the maximum power 23 dBm) according to the PA structure [−3, −7.8, −6, −7.8, −3, −7.8, −6, −7.8], so that 0 dB (i.e., the maximum power 23 dBm) can be reached by only using the second, the third and the fourth antenna groups to transmit.

The layer splits (1, 0, 0, 0), (2, 0, 0, 0), (1, 0, 1, 0), (2, 0, 1, 0), (1, 1, 1, 0), (1, 1, 0, 1), (1, 0, 1, 1), (0, 1, 1, 1), (2, 0, 2, 0), (2, 0, 2, 1), (0, 2, 2, 1), (2, 2, 2, 0), (2, 0, 2, 2) are denoted as G4 in the added fourth column in Table 8. That is, G4={(1, 0, 0, 0), (2, 0, 0, 0), (1, 0, 1, 0), (2, 0, 1, 0), (1, 1, 1, 0), (1, 1, 0, 1), (1, 0, 1, 1), (0, 1, 1, 1), (2, 0, 2, 0), (2, 0, 2, 1), (0, 2, 2, 1), (2, 2, 2, 0), (2, 0, 2, 2)} indicates a subset of layer splits (where the layer splits do not use all 8 antenna ports to transmit) that can be used for full power transmission. The layer splits that uses all 8 antenna ports to transmit, which can naturally reach full power, are not included in G4.

As a whole, according to the second embodiment, the layer splits in each of which only one antenna group (i.e., two antenna ports included in the one antenna group, that are part of the eight antenna ports) or two antenna groups (i.e., four antenna ports included in the two antenna groups, that are part of the eight antenna ports) or three antenna groups (i.e., six antenna ports included in the three antenna groups, that are part of the eight antenna ports) are used to transmit to reach full power are chosen as a subset (e.g., G1, G2, G3, G4) of layer splits (where the layer splits do not use all 8 antenna ports to transmit).

Incidentally, if only one antenna group is used to transmit, the second embodiment chooses the first antenna group as the predetermined one antenna group. It is possible that the second antenna group or the third antenna group or the fourth antenna group is chosen as the predetermined one antenna group.

If only two antenna groups are used to transmit, the second embodiment chooses the first antenna group and the third antenna group as the predetermined two antenna groups. It is possible that the second antenna group and the fourth antenna group are chosen as the predetermined two antenna groups. It can be seen that the first and the third antenna groups have an offset of 2, and the second and the fourth antenna groups also have an offset of 2.

If only three antenna groups are used to transmit, the second embodiment chooses the first, the third and the fourth antenna groups as the predetermined three antenna groups for G3. It is possible that any three of the four antenna groups are chosen as the predetermined three antenna groups (e.g., for G4).

In the first and the second embodiments, a subset of layer splits (where the layer splits do not use all 8 antenna ports to transmit) that can be used for full power transmission is identified for each PA structure for Ng=2 and Ng=4. That is, TMPI groups G0, G1, G2, G3 and G4 are identified. For each of G0, G1, G2, G3 and G4, all layer splits (where the layer splits do not use all 8 antenna ports to transmit) that can be used for full power transmission are included in the TPMI group. In a variety, only a subset of each of G0, G1, G2, G3 and G4, which can be defined and denoted as G0′, G1′, G2′, G3′ and G4′ can be used to replace G0, G1, G2, G3 and G4. As an example, a subset of G4 ({(1, 0, 0, 0), (2, 0, 0, 0), (1, 0, 1, 0), (2, 0, 1, 0), (1, 1, 1, 0), (1, 1, 0, 1), (1, 0, 1, 1), (0, 1, 1, 1), (2, 0, 2, 0), (2, 0, 2, 1), (0, 2, 2, 1), (2, 2, 2, 0), (2, 0, 2, 2)}) can be defined as G4′={(1, 0, 0, 0), (2, 0, 0, 0), (1, 0, 1, 0), (2, 0, 1, 0), (1, 1, 1, 0), (2, 0, 2, 0), (2, 0, 2, 1), (2, 2, 2, 0)}, and G4′ is used in the place of G4.

A third embodiment relates to non-coherent UE full power transmission.

A non-coherent 8TX UE has eight antenna groups each including one antenna port. If a non-coherent 8TX UE needs to transmit with full power, at least one of the 8 PAs associated with the eight antenna ports need to be 0 dB. Without loss of generality, it is assumed that the PA associated with antenna port 0 has 0 dB (i.e., maximal power of 23 dBm), and the PAs associated with antenna ports 1 to 7 have-9 dB. This guarantees that 1 data layer (rank 1) can be transmitted from antenna port 0 with full power. The corresponding TPMI is (1, 0, 0, 0, 0, 0, 0, 0), which can be denoted as G5. That is, G5={(1, 0, 0, 0, 0, 0, 0, 0)}.

A fourth embodiment relates to full power operation based on SRS port virtualization.

Full power transmission can also be supported by SRS port virtualization. That is, the SRS resource set can be configured to be comprised of SRS resources with different number of SRS ports. From the point of view of UE capability, the UE can report the following possible different number of antenna ports that can be configured for a SRS resource:
Value p1-8 means that each SRS resource can be configured with 1 port or 8 ports.
Value p1-2-8 means that each SRS resource can be configured with 1 port or 2 ports or 8 ports.
Value p1-4-8 means that each SRS resource can be configured with 1 port or 4 ports or 8 ports.
Value p1-2-4-8 means that each SRS resource can be configured with 1 port or 2 ports or 4 ports or 8 ports.

When an SRS resource is configured with N ports (e.g., N=2, 4 or 8), N antenna ports can be virtualized as one SRS port.

For example, if the PA structure [−9, −9, −9, −9, −9, −9, −9, −9] is adopted by the UE with non-coherent capability. Full power transmission cannot be supported for less than rank 4 transmission according to the first embodiment or the second embodiment. However, if the first 4 antenna ports can be virtualized as a single SRS port with −3 dB and the last 4 antenna port can be virtualized as another single SRS port with −3 dB, full power transmission for rank 1 and rank 2 can be supported for UE with PA structure [−9, −9, −9, −9, −9, −9, −9, −9].

A fifth embodiment relates to signaling of the TPMI.

Different TPMI groups (G0 or G0′, G1 or G1′, G2 or G2′, G3 or G3′, G4 or G4′, G5) are designed for UEs with different PA structures and are used for UEs with different capabilities (e.g., Ng=2 or Ng=4). These TPMI groups can be defined as part of UE capability in TS38.306. UE may report which one or multiple of these TMPI groups it supports in the UE capability to the base station (e.g., gNB). UE may report index (indices) of these TMPI groups based on its PA structure. When an TPMI (including both the layer split and the precoder used in each antenna group) that is part of the TPMI group Gx (e.g., x is one of 0 to 5) is signaled to the UE in the TPMI field of the DCI format 0_1 or 0_2, UE transmits the PUSCH based on the TPMI using the scaling factor s=1. As defined in NR Release 16 full power mode 2, the power scaling factor s is set to 1 when one of these TPMIs is used to fully utilize the maximal PA power available to these antenna ports.

FIG. 6 illustrates a flowchart of a method 600 in accordance with aspects of the present disclosure. The operations of the method may be implemented by a UE as described herein. In some implementations, the UE may execute a set of instructions to control the function elements of the UE to perform the described functions.

At 602, receiving a DCI format 0_1 or 0_2 scheduling a PUSCH with 8 antenna ports, wherein, the DCI includes a TPMI field, where the TPMI field indicates one of the TPMIs in a set for full power transmission that uses only part of the 8 antenna ports.

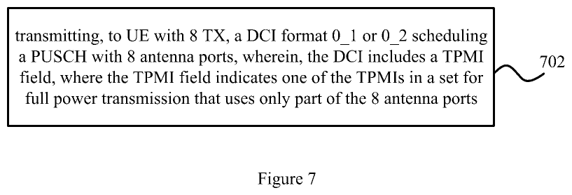

FIG. 7 illustrates a flowchart of a method 700 in accordance with aspects of the present disclosure. The operations of the method may be implemented by a NE as described herein. In some implementations, the NE may execute a set of instructions to control the function elements of the NE to perform the described functions.

At 702, transmitting, to UE with 8 TX, a DCI format 0_1 or 0_2 scheduling a PUSCH with 8 antenna ports, wherein, the DCI includes a TPMI field, where the TPMI field indicates one of the TPMIs in a set for full power transmission that uses only part of the 8 antenna ports.

It should be noted that the method described herein describes a possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

### APPENDIX

TABLE 6.3.1.5-1

| | |
|---|---|
| | Precoding matrix W for single-layer transmission using two |
| | antenna ports. |
| | W |
| TPMI index | (ordered from left to right in increasing order of TPMI index) |

| | | | | | | | | |
|---|---|---|---|---|---|---|---|---|
| 0-5 | $\frac{1}{\sqrt{2}} [ \begin{matrix}1 \\ 0\end{matrix} ]$ | $\frac{1}{\sqrt{2}} [ \begin{matrix}0 \\ 1\end{matrix} ]$ | $\frac{1}{\sqrt{2}} [ \begin{matrix}1 \\ 1\end{matrix} ]$ | $\frac{1}{\sqrt{2}} [ \begin{matrix}1 \\ - 1\end{matrix} ]$ | $\frac{1}{\sqrt{2}} [ \begin{matrix}1 \\ j\end{matrix} ]$ | $\frac{1}{\sqrt{2}} [ \begin{matrix}1 \\ - j\end{matrix} ]$ | — | — |

TABLE 6.3.1.5-2
Precoding matrix W for single-layer transmission using four
antenna ports with transform precoding enabled.

| | W | | | | | | | |
|---|---|---|---|---|---|---|---|---|
| TPMI index | (ordered from left to right in increasing order of TPMI index) | | | | | | | |
| 0-7 | $\frac{1}{2} [ \begin{matrix}1 \\ 0 \\ 0 \\ 0\end{matrix} ]$ | $\frac{1}{2} [ \begin{matrix}0 \\ 1 \\ 0 \\ 0\end{matrix} ]$ | $\frac{1}{2} [ \begin{matrix}0 \\ 0 \\ 1 \\ 0\end{matrix} ]$ | $\frac{1}{2} [ \begin{matrix}0 \\ 0 \\ 0 \\ 1\end{matrix} ]$ | $\frac{1}{2} [ \begin{matrix}1 \\ 0 \\ 1 \\ 0\end{matrix} ]$ | $\frac{1}{2} [ \begin{matrix}1 \\ 0 \\ - 1 \\ 0\end{matrix} ]$ | $\frac{1}{2} [ \begin{matrix}1 \\ 0 \\ j \\ 0\end{matrix} ]$ | $\frac{1}{2} [ \begin{matrix}1 \\ 0 \\ - j \\ 0\end{matrix} ]$ |
| 8-15 | $\frac{1}{2} [ \begin{matrix}0 \\ 1 \\ 0 \\ 1\end{matrix} ]$ | $\frac{1}{2} [ \begin{matrix}0 \\ 1 \\ 0 \\ - 1\end{matrix} ]$ | $\frac{1}{2} [ \begin{matrix}0 \\ 1 \\ 0 \\ j\end{matrix} ]$ | $\frac{1}{2} [ \begin{matrix}0 \\ 1 \\ 0 \\ - j\end{matrix} ]$ | $\frac{1}{2} [ \begin{matrix}1 \\ 1 \\ 1 \\ - 1\end{matrix} ]$ | $\frac{1}{2} [ \begin{matrix}1 \\ 1 \\ j \\ j\end{matrix} ]$ | $\frac{1}{2} [ \begin{matrix}1 \\ 1 \\ - 1 \\ 1\end{matrix} ]$ | $\frac{1}{2} [ \begin{matrix}1 \\ 1 \\ - j \\ - j\end{matrix} ]$ |
| 16-23 | $\frac{1}{2} [ \begin{matrix}1 \\ j \\ 1 \\ j\end{matrix} ]$ | $\frac{1}{2} [ \begin{matrix}1 \\ j \\ j \\ 1\end{matrix} ]$ | $\frac{1}{2} [ \begin{matrix}1 \\ j \\ - 1 \\ - j\end{matrix} ]$ | $\frac{1}{2} [ \begin{matrix}1 \\ j \\ - j \\ - 1\end{matrix} ]$ | $\frac{1}{2} [ \begin{matrix}1 \\ - 1 \\ 1 \\ 1\end{matrix} ]$ | $\frac{1}{2} [ \begin{matrix}1 \\ - 1 \\ j \\ - j\end{matrix} ]$ | $\frac{1}{2} [ \begin{matrix}1 \\ - 1 \\ - 1 \\ - 1\end{matrix} ]$ | $\frac{1}{2} [ \begin{matrix}1 \\ - 1 \\ - j \\ j\end{matrix} ]$ |
| 24-27 | $\frac{1}{2} [ \begin{matrix}1 \\ - j \\ 1 \\ - j\end{matrix} ]$ | $\frac{1}{2} [ \begin{matrix}1 \\ - j \\ j \\ - 1\end{matrix} ]$ | $\frac{1}{2} [ \begin{matrix}1 \\ - j \\ - 1 \\ j\end{matrix} ]$ | $\frac{1}{2} [ \begin{matrix}1 \\ - j \\ - j \\ 1\end{matrix} ]$ | — | — | — | — |

TABLE 6.3.1.5-3
Precoding matrix W for single-layer transmission using four
antenna ports with transform precoding disabled.

| | W | | | | | | | |
|---|---|---|---|---|---|---|---|---|
| TPMI index | (ordered from left to right in increasing order of TPMI index) | | | | | | | |
| 0-7 | $\frac{1}{2} [ \begin{matrix}1 \\ 0 \\ 0 \\ 0\end{matrix} ]$ | $\frac{1}{2} [ \begin{matrix}0 \\ 1 \\ 0 \\ 0\end{matrix} ]$ | $\frac{1}{2} [ \begin{matrix}0 \\ 0 \\ 1 \\ 0\end{matrix} ]$ | $\frac{1}{2} [ \begin{matrix}0 \\ 0 \\ 0 \\ 1\end{matrix} ]$ | $\frac{1}{2} [ \begin{matrix}1 \\ 0 \\ 1 \\ 0\end{matrix} ]$ | $\frac{1}{2} [ \begin{matrix}1 \\ 0 \\ - 1 \\ 0\end{matrix} ]$ | $\frac{1}{2} [ \begin{matrix}1 \\ 0 \\ j \\ 0\end{matrix} ]$ | $\frac{1}{2} [ \begin{matrix}1 \\ 0 \\ - j \\ 0\end{matrix} ]$ |
| 8-15 | $\frac{1}{2} [ \begin{matrix}0 \\ 1 \\ 0 \\ 1\end{matrix} ]$ | $\frac{1}{2} [ \begin{matrix}0 \\ 1 \\ 0 \\ - 1\end{matrix} ]$ | $\frac{1}{2} [ \begin{matrix}0 \\ 1 \\ 0 \\ j\end{matrix} ]$ | $\frac{1}{2} [ \begin{matrix}0 \\ 1 \\ 0 \\ - j\end{matrix} ]$ | $\frac{1}{2} [ \begin{matrix}1 \\ 1 \\ 1 \\ 1\end{matrix} ]$ | $\frac{1}{2} [ \begin{matrix}1 \\ 1 \\ j \\ j\end{matrix} ]$ | $\frac{1}{2} [ \begin{matrix}1 \\ 1 \\ - 1 \\ - 1\end{matrix} ]$ | $\frac{1}{2} [ \begin{matrix}1 \\ 1 \\ - j \\ - j\end{matrix} ]$ |
| 16-23 | $\frac{1}{2} [ \begin{matrix}1 \\ j \\ 1 \\ j\end{matrix} ]$ | $\frac{1}{2} [ \begin{matrix}1 \\ j \\ j \\ - 1\end{matrix} ]$ | $\frac{1}{2} [ \begin{matrix}1 \\ j \\ - 1 \\ - j\end{matrix} ]$ | $\frac{1}{2} [ \begin{matrix}1 \\ j \\ - j \\ 1\end{matrix} ]$ | $\frac{1}{2} [ \begin{matrix}1 \\ - 1 \\ 1 \\ - 1\end{matrix} ]$ | $\frac{1}{2} [ \begin{matrix}l \\ - 1 \\ j \\ - j\end{matrix} ]$ | $\frac{1}{2} [ \begin{matrix}1 \\ - 1 \\ - 1 \\ 1\end{matrix} ]$ | $\frac{1}{2} [ \begin{matrix}1 \\ - 1 \\ - j \\ j\end{matrix} ]$ |
| 24-27 | $\frac{1}{2} [ \begin{matrix}1 \\ - j \\ 1 \\ - j\end{matrix} ]$ | $\frac{1}{2} [ \begin{matrix}1 \\ - j \\ j \\ 1\end{matrix} ]$ | $\frac{1}{2} [ \begin{matrix}1 \\ - j \\ - 1 \\ j\end{matrix} ]$ | $\frac{1}{2} [ \begin{matrix}1 \\ - j \\ - j \\ - 1\end{matrix} ]$ | — | — | — | — |

TABLE 6.3.1.5-4
Precoding matrix W for two-layer transmission using two
antenna ports with transform precoding disabled.

| | W | | |
|---|---|---|---|
| | (ordered from left to right in increasing order of | | |
| TPMI index | TPMI index) | | |
| 0-2 | $\frac{1}{\sqrt{2}} [ \begin{matrix}1 & 0 \\ 0 & 1\end{matrix} ]$ | $\frac{1}{2} [ \begin{matrix}1 & 1 \\ 1 & - 1\end{matrix} ]$ | $\frac{1}{2} [ \begin{matrix}1 & 1 \\ j & - j\end{matrix} ]$ |

TABLE 6.3.1.5-5
Precoding matrix W for two-layer transmission using four
antenna ports with transform precoding disabled.

| | W | | | |
|---|---|---|---|---|
| TPMI index | (ordered from left to right in increasing order of TPMI index) | | | |
| 0-3 | $\frac{1}{2} [ \begin{matrix}1 & 0 \\ 0 & 1 \\ 0 & 0 \\ 0 & 0\end{matrix} ]$ | $\frac{1}{2} [ \begin{matrix}1 & 0 \\ 0 & 0 \\ 0 & 1 \\ 0 & 0\end{matrix} ]$ | $\frac{1}{2} [ \begin{matrix}1 & 0 \\ 0 & 0 \\ 0 & 0 \\ 0 & 1\end{matrix} ]$ | $\frac{1}{2} [ \begin{matrix}0 & 0 \\ 1 & 0 \\ 0 & 1 \\ 0 & 0\end{matrix} ]$ |
| 4-7 | $\frac{1}{2} [ \begin{matrix}0 & 0 \\ 1 & 0 \\ 0 & 0 \\ 0 & 1\end{matrix} ]$ | $\frac{1}{2} [ \begin{matrix}0 & 0 \\ 0 & 0 \\ 1 & 0 \\ 0 & 1\end{matrix} ]$ | $\frac{1}{2} [ \begin{matrix}1 & 0 \\ 0 & 1 \\ 1 & 0 \\ 0 & - j\end{matrix} ]$ | $\frac{1}{2} [ \begin{matrix}1 & 0 \\ 0 & 1 \\ 1 & 0 \\ 0 & j\end{matrix} ]$ |
| 8-11 | $\frac{1}{2} [ \begin{matrix}1 & 0 \\ 0 & 1 \\ - j & 0 \\ 0 & 1\end{matrix} ]$ | $\frac{1}{2} [ \begin{matrix}1 & 0 \\ 0 & 1 \\ - j & 0 \\ 0 & - 1\end{matrix} ]$ | $\frac{1}{2} [ \begin{matrix}1 & 0 \\ 0 & 1 \\ - 1 & 0 \\ 0 & - j\end{matrix} ]$ | $\frac{1}{2} [ \begin{matrix}1 & 0 \\ 0 & 1 \\ - 1 & 0 \\ 0 & j\end{matrix} ]$ |
| 12-15 | $\frac{1}{2} [ \begin{matrix}1 & 0 \\ 0 & 1 \\ j & 0 \\ 0 & 1\end{matrix} ]$ | $\frac{1}{2} [ \begin{matrix}1 & 0 \\ 0 & 1 \\ j & 0 \\ 0 & - 1\end{matrix} ]$ | $\frac{1}{2 \sqrt{2}} [ \begin{matrix}1 & 1 \\ 1 & 1 \\ 1 & - 1 \\ 1 & - 1\end{matrix} ]$ | $\frac{1}{2 \sqrt{2}} [ \begin{matrix}1 & 1 \\ 1 & 1 \\ j & - j \\ j & - j\end{matrix} ]$ |
| 16-19 | $\frac{1}{2 \sqrt{2}} [ \begin{matrix}1 & 1 \\ j & j \\ 1 & - 1 \\ j & - j\end{matrix} ]$ | $\frac{1}{2 \sqrt{2}} [ \begin{matrix}1 & 1 \\ j & j \\ j & - j \\ - 1 & 1\end{matrix} ]$ | $\frac{1}{2 \sqrt{2}} [ \begin{matrix}1 & 1 \\ - 1 & - 1 \\ 1 & - 1 \\ - 1 & 1\end{matrix} ]$ | $\frac{1}{2 \sqrt{2}} [ \begin{matrix}1 & 1 \\ - 1 & - 1 \\ j & - j \\ - j & j\end{matrix} ]$ |
| 20-21 | $\frac{1}{2 \sqrt{2}} [ \begin{matrix}1 & 1 \\ - j & - j \\ 1 & - 1 \\ - j & j\end{matrix} ]$ | $\frac{1}{2 \sqrt{2}} [ \begin{matrix}1 & 1 \\ - j & - j \\ j & - j \\ 1 & - 1\end{matrix} ]$ | — | — |

TABLE 6.3.1.5-6
Precoding matrix W for three-layer transmission using four
antenna ports with transform precoding disabled.

| TPMI | W | | | |
|---|---|---|---|---|
| index | (ordered from left to right in increasing order of TPMI index) | | | |
| 0-3 | $\frac{1}{2} [ \begin{matrix}1 & 0 & 0 \\ 0 & 1 & 0 \\ 0 & 0 & 1 \\ 0 & 0 & 0\end{matrix} ]$ | $\frac{1}{2} [ \begin{matrix}1 & 0 & 0 \\ 0 & 1 & 0 \\ 1 & 0 & 0 \\ 0 & 0 & 1\end{matrix} ]$ | $\frac{1}{2} [ \begin{matrix}1 & 0 & 0 \\ 0 & 1 & 0 \\ - 1 & 0 & 0 \\ 0 & 0 & 1\end{matrix} ]$ | $\frac{1}{2 \sqrt{3}} [ \begin{matrix}1 & 1 & 1 \\ 1 & - 1 & 1 \\ 1 & 1 & - 1 \\ 1 & - 1 & - 1\end{matrix} ]$ |
| 4-6 | $\frac{1}{2 \sqrt{3}} [ \begin{matrix}1 & 1 & 1 \\ 1 & - 1 & 1 \\ j & j & - j \\ j & - j & - j\end{matrix} ]$ | $\frac{1}{2 \sqrt{3}} [ \begin{matrix}1 & 1 & 1 \\ - 1 & 1 & - 1 \\ 1 & 1 & - 1 \\ - 1 & 1 & 1\end{matrix} ]$ | $\frac{1}{2 \sqrt{3}} [ \begin{matrix}1 & 1 & 1 \\ - 1 & 1 & - 1 \\ j & j & - j \\ - j & j & j\end{matrix} ]$ | — |

TABLE 6.3.1.5-7
Precoding matrix W for four-layer transmission using four
antenna ports with transform precoding disabled.

| TPMI | W | | | |
|---|---|---|---|---|
| index | (ordered from left to right in increasing order of TPMI index) | | | |
| 0-3 | $\frac{1}{2} [ \begin{matrix}1 & 0 & 0 & 0 \\ 0 & 1 & 0 & 0 \\ 0 & 0 & 1 & 0 \\ 0 & 0 & 0 & 1\end{matrix} ]$ | $\frac{1}{2 \sqrt{2}} [ \begin{matrix}1 & 1 & 0 & 0 \\ 0 & 0 & 1 & 1 \\ 1 & - 1 & 0 & 0 \\ 0 & 0 & 1 & - 1\end{matrix} ]$ | $\frac{1}{2 \sqrt{2}} [ \begin{matrix}1 & 1 & 0 & 0 \\ 0 & 0 & 1 & 1 \\ j & - j & 0 & 0 \\ 0 & 0 & j & - j\end{matrix} ]$ | $\frac{1}{4} [ \begin{matrix}1 & 1 & 1 & 1 \\ 1 & - 1 & 1 & - 1 \\ 1 & 1 & - 1 & - 1 \\ 1 & - 1 & - 1 & 1\end{matrix} ]$ |
| 4 | $\frac{1}{4} [ \begin{matrix}1 & 1 & 1 & 1 \\ 1 & - 1 & 1 & - 1 \\ j & j & - j & - j \\ j & - j & - j & j\end{matrix} ]$ | — | — | — |

1. A user equipment (UE) for wireless communication, wherein the UE comprises 8 transmitters (TX) and:
at least one memory; and
at least one processor coupled with the at least one memory and configured to cause the UE to:
receive a downlink control information (DCI) format 0_1 or 0_2 scheduling a PUSCH with 8 antenna ports, wherein the DCI includes a transmit precoding matrix indicator (TPMI) field, where the TPMI field indicates one of the TPMIs in a set for full power transmission that uses only part of the 8 antenna ports.

2. The UE of claim 1, wherein, for in response to the UE having two coherent antenna groups each including four antenna ports, the TPMIs in the set only transmit with one of the two coherent antenna groups.

3. The UE of claim 2, wherein one coherent antenna group of the two coherent antenna groups is a predetermined coherent antenna group.

4. The UE of claim 1, wherein, in response to the UE having four coherent antenna groups each including two antenna ports, the TPMIs in the set only transmit one or two or three of the four coherent antenna groups.

5. The UE of claim 4, wherein one coherent antenna group of the four coherent antenna groups is a predetermined coherent antenna group.

6. The UE of claim 4, wherein two coherent antenna groups of the four coherent antenna groups are two predetermined coherent antenna groups.

7. The UE of claim 6, wherein the two coherent antenna groups have an offset of 2.

8. The UE of claim 4, wherein three coherent antenna groups of the four coherent antenna groups are a first, a third, and a fourth coherent antenna groups of the four coherent antenna groups.

9. The UE of claim 1, wherein a power scaling factor is configured to 1.

10. The UE of claim 1, wherein the at least one processor is configured to cause the UE to:
report a capability regarding the set of the TPMIs for full power transmission.

11. The UE of claim 1, wherein the at least one processor is configured to cause the UE to:
report a possible different number of antenna ports that can be configured for a SRS resource for codebook for full power transmission.

12. The UE of claim 11, wherein the possible different number is one of: 1 or 8, 1 or 2 or 8, 1 or 4 or 8, and 1 or 2 or 4 or 8.

13. A processor of a UE for wireless communication, wherein the UE comprises 8 transmitters (TX), and wherein the processor comprises:
at least one controller coupled with at least one memory and configured to cause the processor to:
receive a downlink control information (DCI) format 0_1 or 0_2 scheduling a PUSCH with 8 antenna ports, wherein the DCI includes a transmit precoding matrix indicator (TPMI) field, where the TPMI field indicates one of the TPMIs in a set for full power transmission that uses only part of the 8 antenna ports.

14. A method performed by a user equipment (UE), wherein the UE comprises 8 transmitters (TX), the method comprising:
receiving a downlink control information (DCI) format 0_1 or 0_2 scheduling a PUSCH with 8 antenna ports, wherein the DCI includes a transmit precoding matrix indicator (TPMI) field, where the TPMI field indicates one of the TPMIs in a set for full power transmission that uses only part of the 8 antenna ports.

15. A base station for wireless communication, comprising:
at least one memory; and
at least one processor coupled with the at least one memory and configured to cause the base station to:
transmit, to a UE having 8 transmitters (TX), a downlink control information (DCI) format 0_1 or 0_2 scheduling a physical uplink shared channel (PUSCH) with 8 antenna ports, wherein the DCI includes a transmit precoding matrix indicator (TPMI) field, where the TPMI field indicates one of the TPMIs in a set for full power transmission that uses only part of the 8 antenna ports.

16. The base station of claim 15, wherein, in response to the UE having two coherent antenna groups each including four antenna ports, the TPMIs in the set only transmit with one of the two coherent antenna groups.

17. The base station of claim 15, wherein, in response to the UE having four coherent antenna groups each including two antenna ports, the TPMIs in the set only transmit one or two or three of the four coherent antenna groups.

18. The base station of claim 17, wherein three coherent antenna groups of the four coherent antenna groups are a first, a third, and a fourth coherent antenna groups of the four coherent antenna groups.

19. The base station of claim 15, wherein the at least one processor is configured to cause the base station to:
receive a capability regarding the set of the TPMIs for full power transmission.

20. The base station of claim 15, wherein the at least one processor is configured to cause the base station to:
receive possible different number of antenna ports that can be configured for a SRS resource for codebook for full power transmission.
